(19) United States
(12) Patent Application Publication
(10) Pub. No.: US 2008/0140364 A1
(43) Pub. Date: Jun. 12, 2008

(54) Computer Program Product & Computer with Program to Execute a Well-Posed Mathematical Method

(76) Inventor: George Friedman, Encino, CA (US)

Correspondence Address: CONNORS ASSOCIATES, 1600 DOVE ST, SUITE 220, NEWPORT BEACH, CA, 92660, US

(21) Appl. No.: 11/666,389

(22) PCT Filed: Oct. 27, 2005
(86) PCT No.: PCT/US05/39103

§ 371 Date: Apr. 25, 2007

Related U.S. Application Data
(60) Provisional application No. 60/623,329, filed on Oct. 29, 2004.

(51) Int. Cl. G06F 17/10

(52) U.S. Cl. 703/2

(57) ABSTRACT

A computer determines whether a proposed mathematical model and computational requests made upon the model are well posed. The computer includes a program that determines whether the model is consistent and suggests at least one alternative consistent model if the proposed model is inconsistent. The program also determines whether a computational request is allowable and suggests at least one alternative allowable computational request if an initial computational request is unallowable.

### RELATED PATENT APPLICATION & INCORPORATION BY REFERENCE

This application is a PCT application which claims priority of U.S. provisional patent application Ser. No. 60/623,329, entitled “COMPUTER PROGRAM PRODUCT & COMPUTER WITH PROGRAM TO EXECUTE A WELL-POSED MATHEMATICAL METHOD,” filed Oct. 29, 2004, including the benefit under 35 USC 119(e). This related application is incorporated herein by reference and made a part of this application. If any conflict arises between the disclosure of the invention in this PCT application and that in the related provisional application, the disclosure in this PCT application shall govern. Moreover, the inventor incorporates herein by reference any and all U.S. patents, U.S. patent applications, and other documents, hard copy or electronic, cited or referred to in this PCT application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The words “consisting,” “consists of,” and other forms thereof, are intended to be equivalent in meaning and be closed ended in that an item or items following any one of these words is meant to be an exhaustive listing of such item or items and limited to only the listed item or items.

Constraint Theory: A rigorous mathematical theory that addresses the well posed issues of mathematical modeling; specifically the consistency of the model and the allowability of computations requested on it.

Mathematical Model: A set of variables that describe a complex system or phenomenon, and a set of equations that relate these variables to one another.

Model Consistency: A model is consistent if none of its equations are contradictory to any other equation in the model or to any set of other equations in the model.

Computational Allowability: A computation is allowable if an algorithm can be constructed with independent variables and independent variables held constant as inputs that will produce the requested computation of the dependent variable as the output.

Constraint: The reduction of a set of values variables may take on by the application a set of equations or variables.

Constraint Flow: The flow of computation across a mathematical model due to the application the model's equations and computational request.

Resultant Constraint Domain: The set of equations and variables that the flow of constraint or computation has reached as a result of the existence of an intrinsic constraint source.

Over-constraint: The condition of inconsistency due to the application of the model's equations or computational request.

Under-constraint: The condition where a mathematical model's equations and independent variables are insufficient to provide a computational flow that will result in a value for the dependent variable.

Metamodel: A mathematical structure which describes certain global features of a mathematical model while suppressing most of the detailed features. Constraint theory employs two types of metamodels, a hypergraph and its companion matrix.

Hypergraph: A mathematical structure consisting of two sets of vertices—or junctions—with a set of edges connecting members of one set to members of the other set. The first set of vertices is called nodes—represented by squares—and corresponds to the model's equations. The second set of vertices is called knots—represented by circles—and corresponds to the variables of the mathematical model. When the edges have no direction, the hypergraph represents the mathematical model itself; when the edges have direction (an arrow), the hypergraph represents computational flow.

Companion Matrix: A mathematical structure consisting of a two dimensional array of elements, with the rows representing equations of a mathematical model, the columns representing variables, and cells representing edges which describe the relevancy between variables and equations as well as computational flow.

Homomorphism of Metamodels: The statement “the nodes, knots and edges of the hypergraph are homomorphic to the rows, columns and cells of the companion matrix” means that, given any hypergraph, its companion matrix can be uniquely constructed, and vice versa. Moreover, every operation on the nodes, knots and edges of the hypergraph has a precise counterpart to the rows, columns and cells of the companion matrix, and vice versa.

Sub-model: A subset of a mathematical model's equations with the variables relevant to these equations. Constraint theory employs two types of sub-models. A hypergraph sub-model: a subset of the nodes of the hypergraph with the knots relevant to these nodes connected by edges. A companion matrix sub-model: a subset of the rows of a companion matrix with the columns that have one or more non-zero cells in these rows.

Metamodel Properties:
V=number of vertices (the nodes and knots of a hypergraph) of the hypergraph=the sum of the rows and columns of its companion matrix.
N=number of equations=squares of the hypergraph and number of rows of its companion matrix
K=number of variables=circles of the hypergraph and number of columns of its companion matrix. Note that: V=N+K
E=number of edges of hypergraph (and number of non-zero cells of its companion matrix)
dᵥ=local degree of a vertex=the number of edges which intersect that vertex.

### Structural Properties of Metamodels

Several structural properties of metamodels are listed below in the context of a hypergraph (Its companion matrix has precise corresponding properties, i.e., it is homomorphic.)

(a) Detached Components: Two vertices lie in detached components if there are zero paths of edges connecting them.

(b) Separating Vertex: A vertex that, if removed from the hypergraph, separates a previously connected component of a hypergraph into two or more detached components.

(c) Tree Structure: Two vertices lie in a tree structure if there exists exactly one path of edges that connect them.

(d) Circuit Cluster: Two vertices lie in a circuit cluster if there exist two or more independent paths of edges connecting them. Paths are independent if they only share their initial and terminal vertices.

(e) Kissing Circuit Clusters: Two or more circuit clusters that are connected only by a separating vertex.

(f) Adjacent Circuits: Two circuit clusters are adjacent if they share at least one edge.

(g) Circuit Rank of a connected component equals E−V+1.

(h) Constraint Potential of a sub-model equals N−K.

(i) Nodal Square is a sub-model with N=K

(j) Basic Nodal Square (BNS) is a nodal square with no smaller nodal squares within it.

(k) Intrinsic BNS is a BNS based on the intrinsic structure of a mathematical model prior to the application of a computational request.

(l) Resultant BNS is a BNS that is the result of a computational request or the flow of constraint from another part of the model.

### BACKGROUND OF THE INVENTION

The relentless advance of new technology, as well as the force of mergers and global economies, is forcing systems into ever increasing complexity. This is especially true in the military, space, transportation, communication, energy and commercial arenas. The greatest hope in being able to manage this complexity is through the use of highly dimensional mathematical modeling. By performing computations on a mathematical model of the system, the complex systems' phenomena and performance can be better understood and designs can be controlled and optimized. Using such mathematical models, design and systems engineers can examine a virtually unlimited number of variables, predict behaviors and performance of systems still in their early conceptual stages, optimize the design with respect to detailed criteria, effect interdisciplinary integration, and perform design changes with unprecedented speed and accuracy.

For example, when applied to the aerospace industry, the variables which could be modeled include: total program cost, development cost, operational cost, maintenance cost, system effectiveness, probability of mission success, weight, range, payload, response time, reliability, mean time between failures, failure rate, probability of survival, return on investment, maneuverability, distance, velocity, acceleration, pitch angle, roll angle, yaw angle, force, power, energy, diameter, thrust, and any other quantitative measure of the system design or performance. Unfortunately, the dimensionality of the models makes them incomprehensible to the unaided human mind. Most of the possible computational requests that an analyst may wish the model to perform are not allowable, either because the model is not consistent or because the desired computational flow is not allowable; that is, it is either over-constrained or under-constrained.

These models typically include numerous equations, each equation comprising a dependent variable that is a function one or more independent variables. In addition to the independent variables, the value of dependent variable may also be dependent on a constant that is a component of the equation. Most large models in the range of 100 to 1000 variables cost tens of millions of dollars to build and the managers who authorized these expenditures would like to obtain more use from them than an original targeted computation. As the size of the model increases, the number of allowable computations also increases, but the likelihood of any given request being allowable decreases rapidly because of the exponential increase of all possible computational requests. For small models (say 15 variables), the likelihood of any given computational request being allowable is less than 5%. This decreases rapidly to less than 1% for intermediate models (say 30 variables), and less than 0.1% for models of over 50 variables. Models of 1000 variables may have millions of allowable computations—providing a great richness of understanding and control—but they are buried within many trillions of possible requests.

### SUMMARY OF INVENTION

This invention has one or more features as discussed subsequently herein. After reading the following section entitled “DETAILED DESCRIPTION OF ONE EMBODIMENT OF THIS INVENTION,” one will understand how the features of this invention provide its benefits. The benefits of this invention include, but are not limited to: the rigorous determination and repair of the well-posed properties of mathematical models several orders of magnitude more efficiently than brute force methods.

Without limiting the scope of this invention as expressed by the claims that follow, some, but not necessarily all, of its features are:

One, this invention is a computer programmed to test the consistency of a proposed mathematical model and the allowability of a computational request and a computer program product storing the program. The program may provide to a human operator through an output device an advice that the proposed mathematical model is inconsistent. This advice may suggest one or more alternative consistent mathematical models when the proposed model is inconsistent. When the proposed model is consistent, the program may also provide to a human operator through an output device an advice when the computational request is unallowable. The program may also provide an advice to the human operator suggesting one or more alternative allowable computational requests when an imposed computational request is unallowable.

Two, the proposed mathematical model typically includes a plurality of variables and equations relating the variables to one another. A companion matrix of a hypergraph of the proposed mathematical model is used. The invention advantageously employs this companion matrix and the program interacts with the companion matrix, and may include one or more of the following routines:
(a) a routine that constructs a companion matrix of a hypergraph of the proposed mathematical model,
(b) a routine that identifies any overlapping basic nodal squares within the companion matrix and any overlapping resultant constraint domains emanating from any so identified basic nodal square or squares,
(c) a routine that generates an advice that the proposed mathematical model is inconsistent when an overlapping basic nodal square, or an overlapping resultant constraint domain thereof, is present within the companion matrix,
(d) a routine that calculates a resultant constraint potential at each vertex and circuit clusters along a computational path from all independent variables, and all independent variable held constant, to a dependent variable,
(e) a routine that generates an advice that the computational request is unallowable when the resultant constraint potential is not equal to zero at each vertex or circuit cluster or both along the entire computational path,
(f) a routine that identifies within said companion matrix sub-models comprising nodes, knots, and edges identifying related nodes and knots and computes circuit rank of a sub-model using the formula

CR=E−(N+K)+1
where
   CR is circuit rank,
N equals the number of nodes in the connected sub-model,
K equals the number of knots in the connected sub-model,
E equals the number of edges in the connected sub-model,
   if CR is 0, then the sub-model has a tree structure,
   if CR>0, then the sub-model has a circuit cluster,
and
(g) a routine that identifies any basic nodal square within any identified circuit cluster or clusters, and if any so identified basic nodal square or squares, or a resultant constraint domains emanating from any so identified basic nodal square or squares, overlap.
(h) a routine that temporarily suspends from the companion matrix for the purpose of identifying a basic nodal square any sub-models having a tree structure.
(i) a routine that temporarily suspends from the companion matrix for the purpose of identifying a basic nodal square any connected sub-model that has a circuit rank equal to zero.

One embodiment of this invention is a computer including a memory in which is stored a companion matrix of a hypergraph of a proposed mathematical model, and a program that executes in conjunction with the matrix the following routines in sequence:

(a) a routine that identifies each connected component within the model, thereby determining if the model is a single, unitary connected component or comprises two or more detached connected components,

(b) a routine that determines whether any connected component identified by the routine of paragraph (a) is a tree structure by computing the circuit rank of each connected component,

(c) a routine that for each connected component identified by the routine of paragraph (b) as not being tree structure determines if any external tree structure exists therein and temporarily suspends from further analysis any so identified external tree structure, thereby identifying any first circuit cluster within said connected component analyzed,

(d) a routine that determines if any internal tree structure exists within said a first circuit cluster identified by the routine of paragraph (c), and if so, temporarily suspends from further analysis any so identified internal tree structure, thereby identifying one or more second circuit clusters within said first circuit cluster,

(e) a routine that identifies all kissing circuit clusters within any of the second circuit clusters identified by the routine of paragraph (d), thereby identifying any circuit clusters that may contain a nodal square,

(f) a routine that identifies any basic nodal square within any nodal square identified by the routine of paragraph (e),

(g) a routine that determines whether any basic nodal squares identified by the routine of paragraph (f), and resultant constraint domains thereof, overlap,

(h) a routine that, in the case of an overlap identified by the routine of paragraph (f), provides an advice to a human operator that the model is inconsistent,

(i) a routine that enables a human operator to impose on a consistent model a computational request and determines if the request is allowable.

In this one embodiment, the program may include a routine that provides an advice suggesting one or more alternative consistent mathematical models when the proposed model is inconsistent. Also, the program may include a routine that provides an advice suggesting one or more alternative allowable computational requests when an imposed computational request is unallowable.

Another embodiment of this invention is a computer comprising a memory storing a program and a processor for executing the program, where the program includes:
a matrix construction routine that constructs a companion matrix of a hypergraph of the mathematical model to provide a homomorphic counterpart of the hypergraph that enables the processor to execute the following routines to determine if the model in consistent and if a computational request imposed on the model is allowable,
the matrix having intersecting rows and columns of cells, with each individual row of cells being a node corresponding to one equation of the model, each individual column of cells being a knot corresponding to one variable of the equations, the routine identifying each individual cell as an edge wherever a node and knot are related, a routine that analyzes the matrix using a connectivity algorithmic process to identify any mutually exclusive and exhaustive connected components of the model,
a routine that for each connected component computes circuit rank using the formula CR=E−(N+K)+1, where
   CR is the circuit rank of a component,
   E is the number of edges in a connected component,
   N is the number of nodes in a connected component,
   K is the number of knots in a connected component,

when CR=0, a connected component is a tree structure,

when CR is >0, a connected component includes at least one circuit cluster,
a routine that temporarily suspends from further analysis any portion of the matrix identified as an external tree structure,
a routine that analyzes each identified circuit cluster using a connectivity algorithmic process to identify any internal tree structures and kissing clusters within the circuit cluster being analyzed, and temporarily suspends from further analysis any portion of the matrix identified as an internal tree structures or kissing clusters or both, to thereby identify target portions of the matrix where a nodal square may exist,
a routine that analyzes the target portions of the matrix to identify any sub-model therein that contains a nodal square by determining if a sub-model has a constraint potential equal to zero using the formula

p(HG)=N−K
where
   p(HG) is the constraint potential
   N is the number of nodes in the sub-model
   K is the number of knots in the sub-model,
a routine that identifies within any nodal square any basic nodal square,
a routine that determines whether any basic nodal squares, and resultant constraint domains thereof, overlap, whereby overlapping identifies an inconsistent mathematical model, and activates a consistency repair advice routine suggesting an alternate consistent mathematical model,
a routine that determines the allowability of a computational request imposed on a consistent mathematical model by calculating a constraint potential p(HG) at every node and knot along a computational flow path extending from all independent variables and all variables held constant to the dependent variable, and enables the computational request to be imposed on the consistent mathematical model if the resultant constraint potential is equal to zero at each said node and knot, and if not, activates a computational request repair advice routine suggesting one or more alternate allowable computational requests.
   The consistency repair advice routine provides an advice that suggests removing one or more of the equations from the sub-model corresponding to the overlapping basic nodal squares or converting one or more constants in said sub-model equations to a variable so that there are no longer overlapping basic nodal squares. The consistency repair advice routine provides an advice that suggests converting one or more of the constants in the sub-model equations of the overlapping basic nodal squares or constrain domains thereof to a variable, thus rendering the basic nodal square into a sub-model with a constraint potential equal to or less than zero. In the case that constraint potential is greater than zero at any node or knot along the path, the computation is over-constrained and not allowable. In the case that the constraint potential is less than zero at any node or knot along the path, then the computation is under-constrained and not allowable. In such cases, the computational request repair advice routine provides an advice that adjustments must be made to the choice of independent variables, variables held constant, and dependent variables in order to bring the resultant constraint potential to zero along the entire path, thus obtaining allowable computational requests. When over-constraint occurs, the advice suggests (a) lowering the constraint by the elimination of basic nodal squares forming a consistent sub-model, or (b) converting constants to variables. When under-constraint occurs, the advice suggests increasing the constraint by holding an appropriate number of variables forming a consistent sub-model at constant values. The algorithmic connectivity process comprises

(a) starting at any cell corresponding to a node or a knot and propagating connectedness along the cells corresponding to edges from said node or knot in all possible directions,

(b) repeating step (a) if a first iteration of step (a) does not fill up the entire model, starting again at any node or knot which is not reached by the first iteration, and

(c) if needed to completely decompose the entire hypergraph, continually repeating propagating connectedness along the edges from any un-reached node or knot in all possible directions.

This invention includes a computer program product for controlling a computer to execute a program that determines (1) the consistency of a mathematical model including a plurality of equations, each equation comprising one or more independent variables, and (2) the allowability of a computational request imposed on the model. The program is stored by the product and has several routines. These routines include

a routine that constructs a companion matrix of a hypergraph of the mathematical model, said companion matrix including rows and columns that intersect to form a cell at each intersection, where each row corresponds to one equation and each column corresponds to one variable,

a routine that identifies each cell that relates an equation and to a variable,

a routine that locates within the companion matrix one or more basic nodal squares,

a routine that determines if any of the basic nodal squares overlap and if any resultant constraint domains emanating from the basic nodal squares overlap,

a routine that provides an advice that the model is inconsistent if any of the basic nodal squares, or if any resultant constraint domains, overlap,

a routine that determines the allowability of a computational request imposed on a consistent mathematical model, and

a routine that imposes an allowable computational request on a consistent mathematical model.

### The routine that determines the allowability of a computational request imposed on a consistent mathematical model comprises

a routine that constructs a companion matrix of a directed hypergraph of the consistent mathematical model,

a routine that identifies a computational flow path for a specific computational request imposed on the consistent mathematical model, said path including all independent variables and variables held constant, and a dependent variable corresponding to the specific computational request, and

a routine that calculates a constraint potential along the entire computational flow path and, if the constraint potential equals zero along the computational flow path, the computational request is allowable.

Another embodiment of the computer program product of this invention comprises

a routine that constructs a companion matrix of the model corresponding to the model's hypergraph,

a routine that identifies by a process of elimination any basic nodal squares within the companion matrix that do not overlap and do not have overlapping resultant constraint domains emanating from the identified basic nodal squares, thereby confirming that the model is consistent,

a routine that determines the allowability of a computational request imposed on a consistent mathematical model, and

a routine that imposes an allowable computational request on a consistent mathematical model.

These features are not listed in any rank order nor is this list intended to be exhaustive.

### DESCRIPTION OF DRAWING

One embodiment of this invention, illustrating all its features, will now be discussed in detail. As shown in the accompanying drawing, which is for illustrative purposes only, this embodiment depicts the novel and non-obvious computer program product and computer of this invention for determining the consistency of a mathematical model and whether a computational request imposed on a consistent model is allowable. Furthermore, if not consistent or allowable, this embodiment provides advice to the human operator to achieve consistency and allowability. This drawing includes the following figures (Figs.):

FIG. 1 is an example of a typical mathematical model.

FIG. 2 is a hypergraph of the mathematical model shown in FIG. 1.

FIG. 2A is a directed hypergraph of the mathematical model shown in FIG. 2 when a computational request has been imposed on the model.

FIG. 3 is a companion matrix of the hypergraph shown in FIG. 2.

FIG. 4 is an illustration of the metamodel properties of the hypergraph shown in FIG. 2.

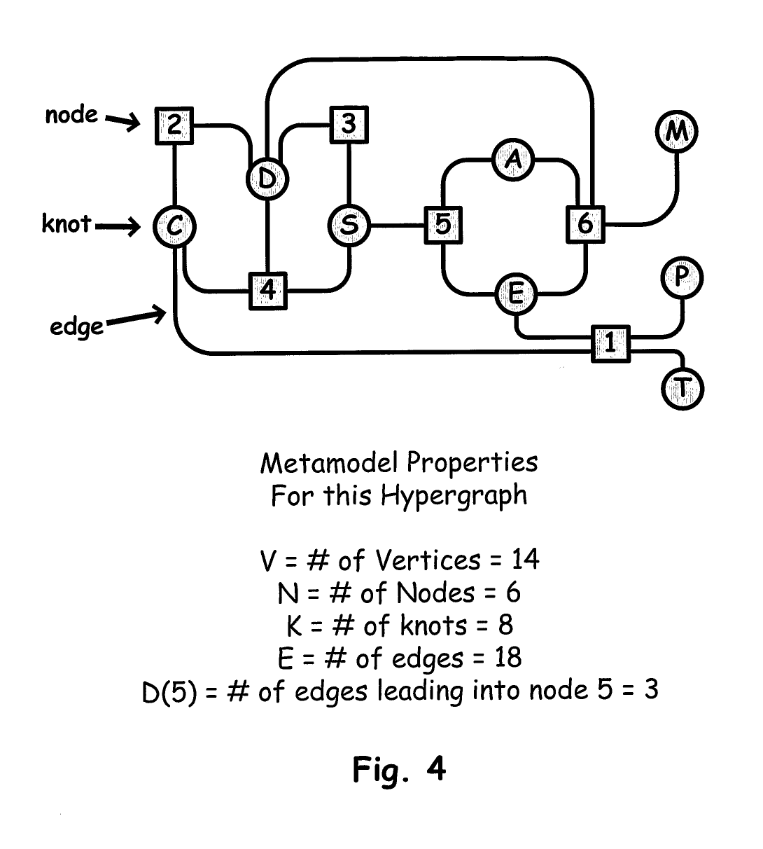

FIG. 5 is a companion matrix of a hypergraph showing a nodal square and a basic nodal square within the nodal square.

FIG. 6 is an illustration of a metamodel as a hypergraph with detached connected components and the structural properties of this metamodel.

FIG. 7 is a diagram illustrating constraint flow rules in tree structures.

FIG. 8 is a diagram of a computer programmed in accordance with this invention.

FIG. 9 is a top-level process flow diagram of the master program installed in the computer depicted in FIG. 8.

FIG. 10 is a process flow diagram of the consistency subprogram of the master program.

FIG. 11 is a diagram illustrating constructing hypergraph and companion matrix metamodels.

FIG. 12 is a process flow diagram illustrating locating a basic nodal square.

FIG. 13 is a hypergraph with tree structures and kissing circuit clusters illustrating identifying a BNS's with a connected component.

FIG. 13 A is a hypergraph with a pair of kissing circuit clusters.

FIG. 13B is a companion matrix of the hypergraph shown in FIG. 13A.

FIG. 14 is a process flow diagram illustrating decomposing of a hypergraph into its separate components.

FIG. 15 is a process flow diagram illustrating identifying tree structures by computing circuit rank.

FIG. 16 is a process flow diagram illustrating a tree trimming routine.

FIG. 17 is a process flow diagram illustrating separating kissing circuit clusters.

FIG. 18 is a process flow diagram illustrating locating basic nodal squares.

FIG. 19 is a process flow diagram illustrating identifying overlapping basic nodal squares.

FIG. 20 is an illustration of overlapping basic nodal squares.

FIG. 21A is a hypergraph depicting intrinsic constraint sources.

FIG. 21B is a hypergraph illustrating overlapping resultant constraint domains.

FIG. 21C is a companion matrix of the companion matrix of the hypergraph shown in FIG. 21B.

FIG. 21D is a process flow diagram depicting identifying resultant constraint domains and determining if such domains overlap.

FIG. 22 is a hypergraph being tested for the existence of any resultant BNS's.

FIG. 23 is process flow diagram illustrating the consistency repair advice subprogram of the master program.

FIG. 24 is an illustration of a consistency repair advice suggesting elimination of certain equations from a mathematical model where overlapping BNS's have been detected.

FIG. 25 is an illustration of a consistency repair advice suggesting elimination of certain equations from a mathematical model where overlapping constraint domains have been detected.

FIG. 26 is process flow diagram illustrating the computational allowability subprogram of the master program.

FIG. 27 is process flow diagram illustrating using a directed hypergraph and companion matrix in conjunction with a computational request.

FIG. 28 is process flow diagram recapitulating the rule for constraint flow in tree structures as applied to a computational request.

FIG. 29 is process flow diagram illustrating the computational allowability repair advice subprogram of the master program.

FIG. 30A is an illustration of an advice provided by the computational allowability repair advice subprogram if the computational request is under-constrained.

FIG. 30B is an illustration of an advice provided by the computational allowability repair advice subprogram if the computational request is over-constrained.

FIG. 31 is process flow diagram illustrating the computational request activation subprogram of the master program.

FIG. 32A is a hypergraph of a mathematical model depicting a complex system.

FIG. 32B is a companion matrix of the hypergraph shown in FIG. 32A.

FIG. 33A is the hypergraph of the FIG. 32A decomposed into a connected component.

FIG. 33B is a companion matrix of the hypergraph shown in FIG. 33A with certain cells shown as temporarily suspended.

FIG. 34A is the hypergraph of the sub-model depicted in FIG. 33A with external tree structures temporarily suspended.

FIG. 34B is a companion matrix of the hypergraph shown in FIG. 34A with certain cells shown as temporarily suspended.

FIG. 35A is the hypergraph of the sub-model depicted in FIG. 34A with an internal tree structure temporarily suspended.

FIG. 35B is a companion matrix of the hypergraph shown in FIG. 35A with certain cells shown as temporarily suspended.

### DETAILED DESCRIPTION OF ONE EMBODIMENT OF THIS INVENTION

### Constraint Theory

To appreciate this invention one needs an understanding of a branch of mathematics known as “constraint theory.” Constraint theory provides a mathematically rigorous method for determining the consistency of any mathematical model—no matter how many equations it may include—and to assess the allowability of any computational request imposed on the model. Constraint theory employs graph theory—in particular hypergraphs—to develop a topological structure of the model and a companion matrix. In accordance with this invention, the companion matrix is used to communicate the structure of the model to a computer properly programmed so the computer can automatically determine the consistency of the model and the allowability of requested computations.

A key feature of constraint theory is the identification of a mathematical structure called the “basic nodal square” (BNS) as the kernel of constraint. Locating a BNS's within a model is crucial to the determination of a model's consistency and a computation's allowability. Even assuming a nanosecond cycle time on a computer, finding even a 100 variable model's BNS's by an exhaustive search of all possible models requires tens of billions of years. In contrast, by employing easily computed topological properties of a model's hypergraph, constraint theory can accelerate this process by a factor of a trillion (10²⁴).

An early application of constraint theory can be to increase the power of spreadsheets that are increasingly being used to characterize engineering models. Typically, in building a spreadsheet, the independent variables are all chosen ahead of time and a dependent variable is computed. In the so-called “what if” mode, several attempts are made at choosing values for the “input vector” (the selection of those variables to be independent) as the definition of “what if,” and the output behavior is observed and hopefully optimized. The model would be far more valuable if the human analyst could interchange input and output, that is, independent variables (and some variables that may be held constant) to obtain greater understanding and use of the model.

Modern spreadsheets can handle over 100 variables and, as mentioned above, could possibly provide millions of computations in addition to the original defined computation. However, the human analyst must find these in the thicket of the many trillions of potential computations. Constraint theory can identify for the human analyst examining a spreadsheet which computations are allowable. Additionally, it can provide a computational flow diagram to the spreadsheet program on how to develop any allowable computation.

### Theory Principles

The following constraint theory principles are mathematically rigorous; and the proofs thereof can be found in: “Constraint Theory Applied to Mathematical Model Consistency and Computational Allowability”—PhD dissertation, UCLA, 1967, University Microfilms, Inc, Ann Arbor, Mich.

In order for a computational request on a mathematical model to be allowable, the models must be consistent. No computation involving variables from separated components can be allowable. The basic nodal square (BNS) is the source of point constraint in all models, which are comprised of equations that can compute the value of any of its variables, given that that values are assigned to all its other variables. Any set of N simultaneous equations involving K variables can be solved for unique (or sets of unique) values if N=K. Overlapping basic nodal squares (BNS's), or overlapping resultant constraint domains, are the cause of over-constraint and inconsistency in mathematical models. Every basic nodal square (BNS) must lie within the union of adjacent circuits within a single circuit cluster. From the practical standpoint of locating BNS's, this means that no BNS cannot lie across connected components, cannot lie within any tree structure or structure with a tree appendage, and cannot lie across kissing circuit clusters. The following computational flow rules apply: In a tree structure, computation will flow across a hypergraph if, for nodes, (dᵥ−1) inputs results in 1 output, and, for knots, 1 input results in (dᵥ−1) outputs, where dᵥ equals the number of edges that intersect a vertex (a node or a knot). In a general hypergraph, a computational request is allowable only when the resultant constraint potential at every vertex and every circuit equals zero along the entire computational path from independent variables and variables held constant to the dependent variable. If the resultant constraint potential is greater than zero, the request is not allowable due to over-constraint. If the resultant constraint potential is less than zero, the request is not allowable due to under-constraint. (It is possible for a single computational request to be both over and under-constrained—at different points along the path.)

### DETAILED DESCRIPTION OF THE INVENTION

### General Features of the Invention

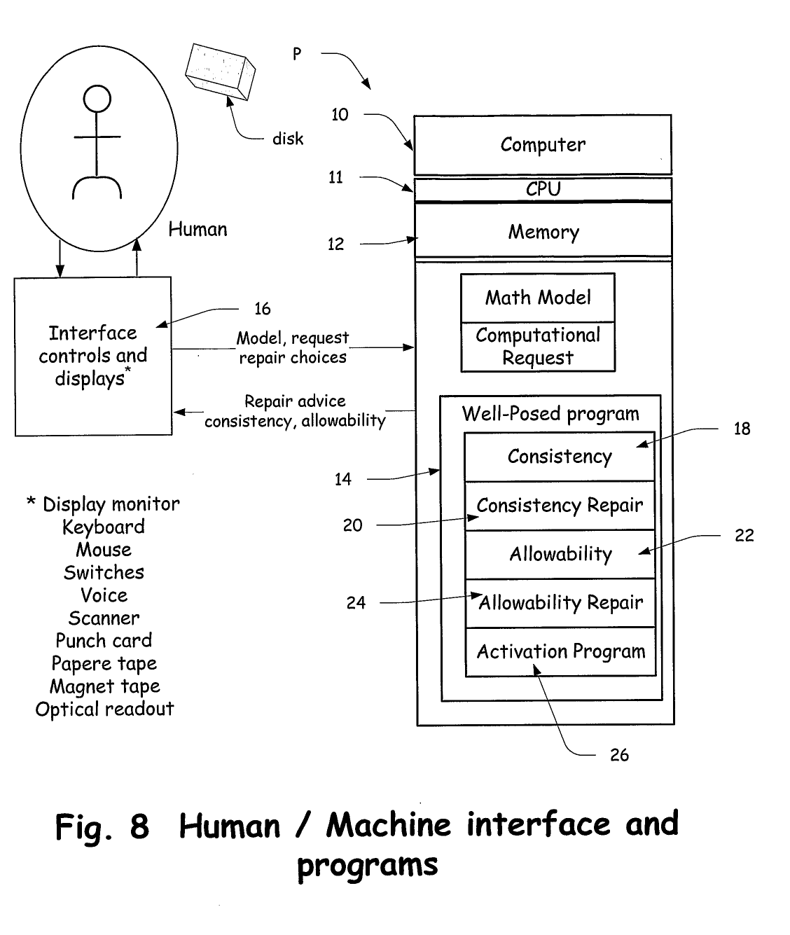

As illustrated in FIG. 8, this invention comprises a computer 10 including a master program 14 (discussed subsequently in greater detail) retained within the computer's memory 12 that executes a well-posed mathematical method. The master program 14 is constructed in accordance with conventional programming techniques using a language suitable for general-purpose computers to create source code and object code for executing the routines (discussed subsequently in greater detail) of the master program 14. This master program 14 may be included in a computer program product P of this invention and transferred to the memory 12 from this product. The computer program product comprises the master program 14 retained on a recording medium suitable for use with a digital computer, for example, a DVD disk, tapes, printouts, etc. The master program 14 is installed or downloaded from the recording medium into the memory 12 of the computer 10. Alternately, the master program 14 may be written directly into the memory 12 or even downloaded from a website or transferred via email to the computer 10. The computer's central processing unit 11 executes the master program 14.

A human operator, directly or indirectly, inputs into the memory 12 a mathematical model upon which a computational request is imposed. The program 14 constructs within the memory 12 a companion matrix CM of a hypergraph of the mathematical model. The program 14 executes its various routines using this CM, which is like a spreadsheet application program with cells relating equations to variables. The EXAMPLE, discussed subsequently in detail, depicts how the program 14 interacts with a specific companion matrix 102b. The program 14 identifies an inconsistent mathematical model. If necessary, the program 14 also provides an advice suggesting how to alter the model to make it consistent. The program 14 identifies any unallowable computational request imposed on a consistent model. If necessary, it also provides an advice suggesting how to alter the computational request to make it allowable.

The following summarizes the main routines of the program 14 and uses different hypergraphs to illustrate visually the mathematical principles under discussion. The companion matrix CM that corresponds to a hypergraph of the mathematical model under consideration is lodged in the computer's memory 12. It is this companion matrix CM upon which the operations of the routines act in accordance with encoded instructions of the program 14. Because the companion matrix CM and its hypergraph are homomorphic, they are fully equivalent. Consequently, in the following discussion, reference is sometimes made to a companion matrix CM or to its hypergraph for clarity.

### Main Routines

### 1. Routine for Construction of Hypergraph (HG)

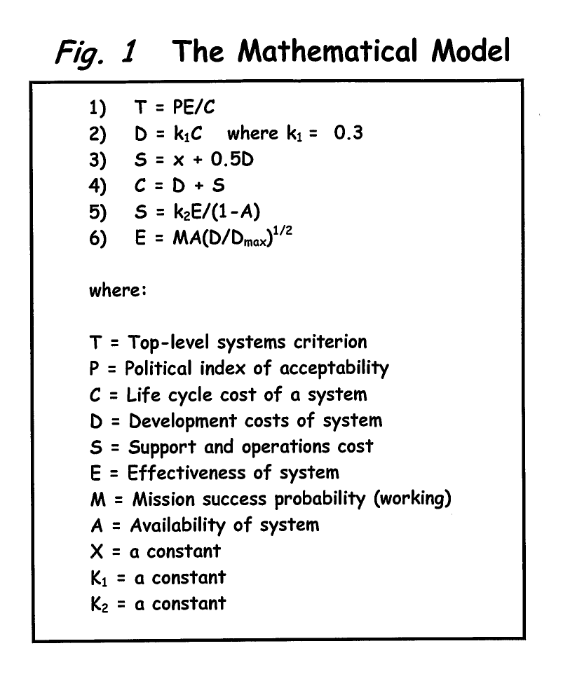

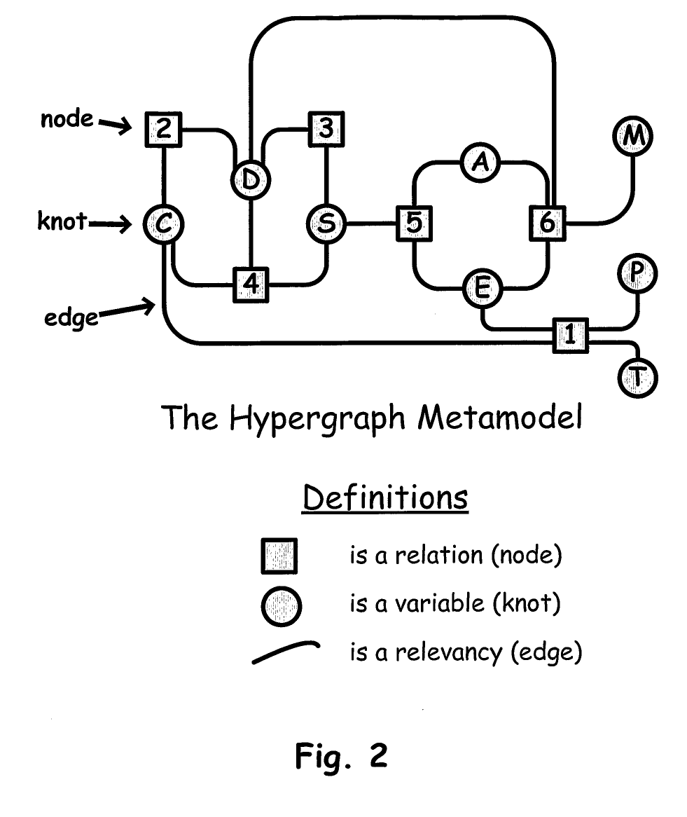

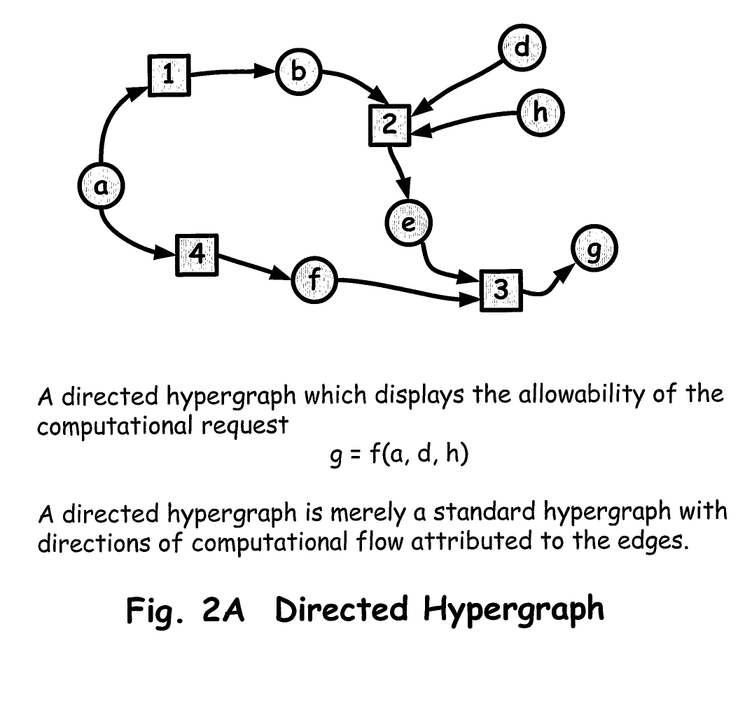

A hypergraph (HG) is defined as two disjoint sets, nodes {N} and knots {K}, with edges {E} connecting elements of these sets such that only an element in {N} can be connected with an element in {K}. (Connecting two elements in {N} or two elements in {K} violates the definition of a HG.) To construct a constraint theoretic hypergraph HG metamodel of a mathematical model (for example the model illustrated in FIG. 1), perform these three steps as shown in FIG. 2:

a) Associate every equation in the mathematical model with an element of {N}, draw it as a square (called a “node”) and label each square with a corresponding equation number, in this case 1 through 6.

b) Associate every variable in the mathematical model with an element in {K}, draw it as a circle (called a “knot”) and label each circle with its corresponding variable letter, in this case A, C, D, E, M, P, S and T.

c) Connect nodes to knots with edges whenever the variable is relevant to the equation.

As depicted in FIG. 2, hypergraphs with undirected edges (no arrow heads) represent mathematical metamodels. As illustrated in FIG. 2A, hypergraphs with directed edges (employing arrow heads) represent computational flow.

### 2. Routine for Companion Matrix (CM) Construction Process.

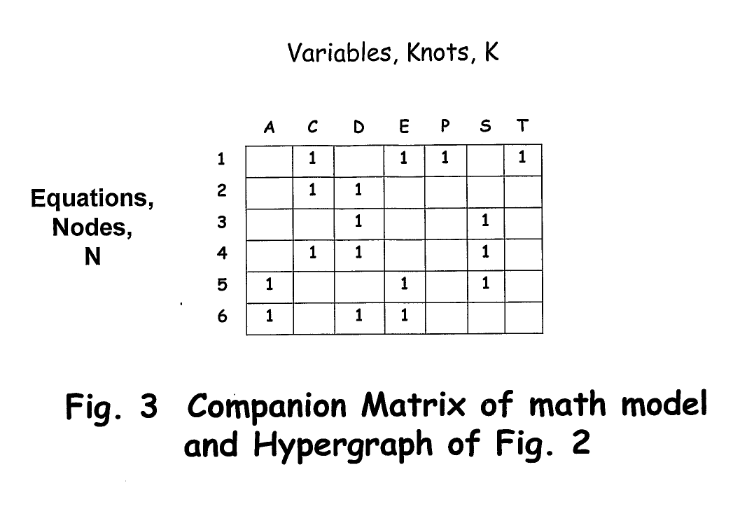

As depicted in FIG. 3, starting with the HG of a mathematical model shown in FIG. 1, draw a rectangular matrix with the equations in {N} as the rows and the variables in {K} as the columns. If the variable C is relevant to the equation 2 then the cell 2C of the matrix includes the symbol, for example, a slash (/), otherwise it is empty or includes the symbol zero, i.e., cell 2E is empty. The companion matrix CM will be the primary method of communicating the information in the HG to a digital computer for computer-assisted analysis of mathematical models.

### 3. Routine for Computation of Constraint Potential p(HG) of a Hypergraph HG.

For any hypergraph, or sub-graph or sub-model, HG, the constraint potential, p(HG), equals the number of nodes N in the graph minus the number of knots K in the hypergraph, or sub-graph or sub-model. That is: p(HG)=N−K.

### 4. Routine for Detection of Basic Nodal Square (BNS)

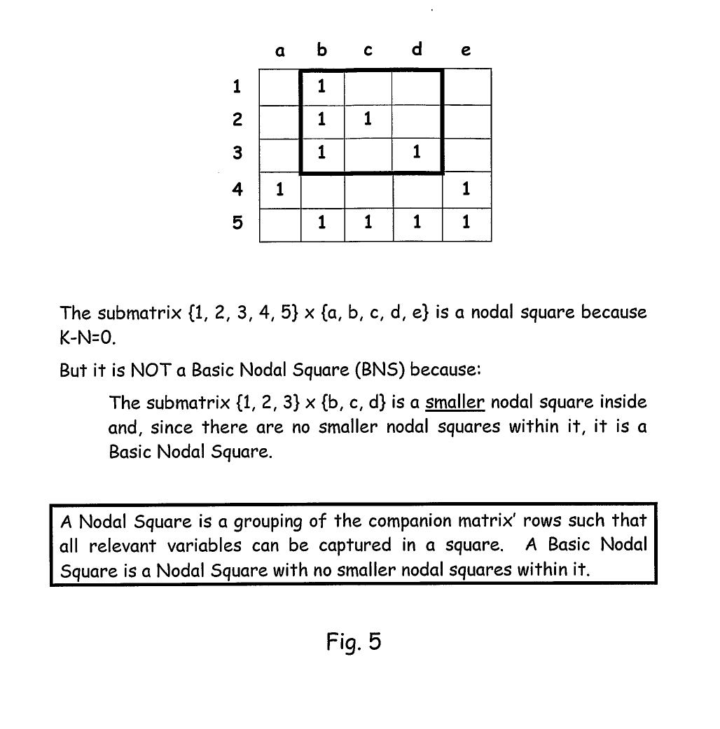

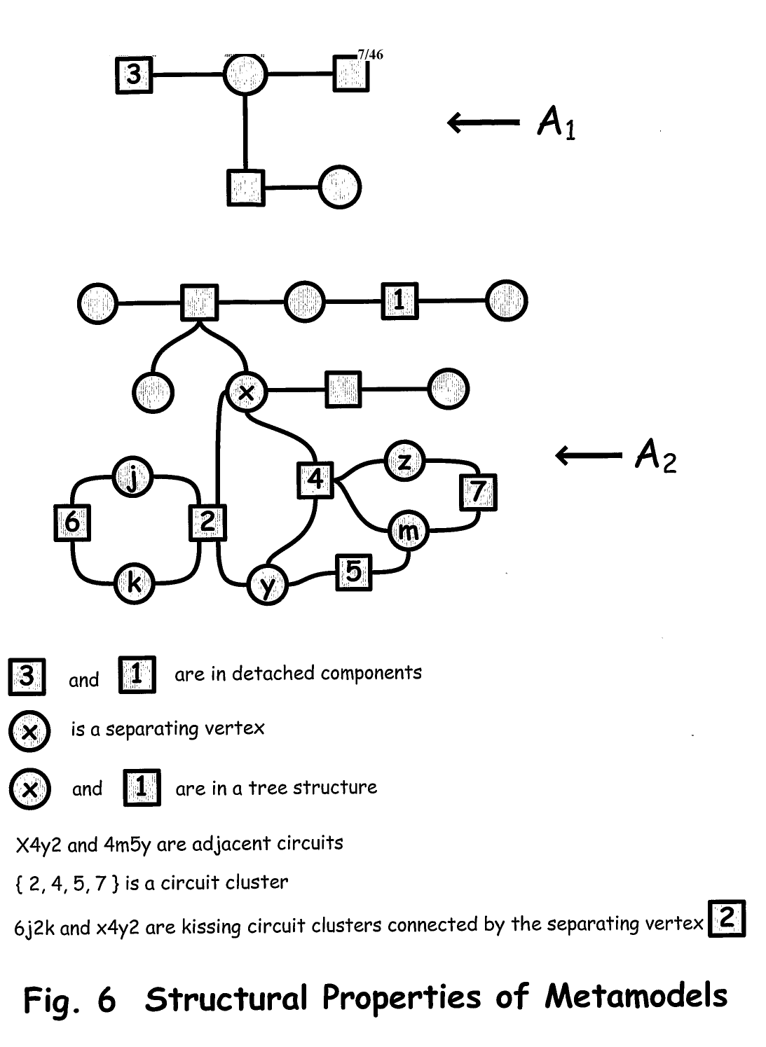

A sub-model of a HG is a subset of the model's nodes, along with their relevant variables. FIG. 5 depicts a relationship of five equations (nodes, N) numbered 1 through 5 including five variables (knots, K) identified by the Roman letters a through e. A nodal square (NS) is a sub-model with a constraint potential p(NS)=N−K=0. A basic nodal square (BNS) is a nodal square that does not contain a smaller nodal square within it. A basic nodal square is detected by examining connected sub-models within the hypergraph, checking for a constraint potential equal to zero, and noting that all BNS's must lie across the union of adjacent circuits. Refer to FIG. 6 for examples of adjacent circuits.

### 5. Routine for Applying Constraint Flow Rules in a Tree Structure of a Hypergraph.

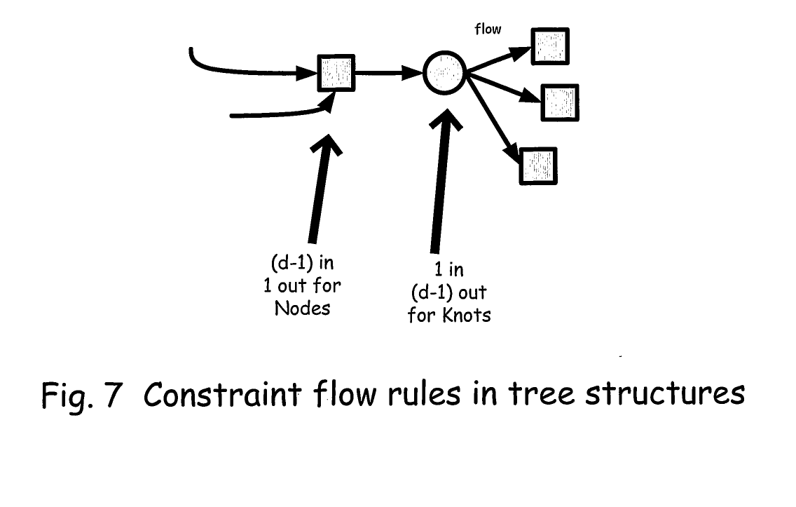

A tree in a hypergraph HG is defined as a structure such that there exists exactly one path between any pair of its vertices {N} or {K}. FIG. 6 depicts a hypergraph with a pair of disconnected sub-graphs A₁ and A₂. The local degree, dᵥ of any vertex is the number of edges that intersect it. As depicted in FIG. 7, the propagation of constraint—or computational flow—follows these rules:

For Nodes: (dᵥ−1) inputs will permit 1 output

For Knots: 1 input will permit (dᵥ−1) outputs

### 6. Routine for Determining Connectedness in a Hypergraph HG.

Two sub-models (or sub-graphs) are connected if there exists at least one path connecting them; if not, they are detached. A connectivity routine starts at any vertex in the hypergraph under examination and propagates connectedness along its edges in all possible directions. If this routine does not fill up the entire hypergraph HG (or companion matrix), then start again at any vertex that was not reached by the first step and repeat the connectedness flow along the edges in all directions. Repeat until the entire hypergraph HG has been reached. This process will decompose any hypergraph HG into mutually exclusive and exhaustive, connected sub-models.

### 7. Routine for Determining if Tree Structures exist in a Hypergraph HG.

In any connected component of a hypergraph HG, if the circuit rank (CR)=E−V+1=E−(N+K)+1=0, then the connected component is a tree structure. If E−V+1>0, then the connected component is or contains a circuit cluster. If E−V+1<0, then it is a detached or disconnected sub-model.

### 8. Mathematical Model Consistency Routine

Mathematical model inconsistency only occurs when BNS's overlap, or the constraint domains flowing out from them overlap. Thus, to determine mathematical model consistency, it is necessary to locate all its BNS's by analyzing each model's constraint and topological properties. The above routines are employed in the sequence shown in functional flow diagrams to locate all the model's BNS's. Since no computation can be allowable on an inconsistent model, some of the overlapping BNS's have to be eliminated, creating a consistent mathematical model before computational requests can be entertained.

### 9. Consistency Repair Routine

If the model's consistency routine detects overlapping BNS's, or overlapping constraint domains. the model is inconsistent and can be repaired by either: a) removing one or more of the overlapping BNS's so that there are no longer overlapping BNS's, or b) converting one or more of the constants in the equations of the overlapping BNS's to a variable, thus rendering the model consistent.

### 10. Computational Allowability Routine

The resultant constraint potential at any vertex of a hypergraph HG equals its intrinsic constraint plus the constraint either flowing in or out of that vertex. In order for a computational request to be allowable, the resultant constraint potential at every vertex and at every circuit cluster along the entire path from independent variables and variables held constant to the dependent variable must equal exactly zero. If the resultant constraint potential is greater than zero at any point along the path, the computation is over-constrained and therefore not allowable. If the resultant constraint potential is less than zero at any point along the path, then the computation is under-constrained at different vertices or circuit clusters along the path, and therefore not allowable. It is possible for the same computation to be both over- and under-constrained. In these cases, adjustments must be made to the choice of independent variables, variables held constant, and dependent variables in order to obtain allowable computational requests or defines them as independent variables.

### 11. Computational Request Repair Routine

If the computational request process routine indicates that the computational request is not allowable then there exists either over- or under-constraint (or both) along the path from independent variables, and variables held constant, to the dependent variable. Wherever over-constraint occurs, the process lowers the constraint by the elimination of BNS's at that location, or by the conversion of constants to variables. Wherever under-constraint occurs, the process increases the constraint by holding an appropriate number of variables at that location at constant values.

The routines identified above—in the sequence and flow discussed subsequently—determine the consistency of the mathematical model, a repair advice to achieve allowability if necessary of computational request imposed on a consistent model, and allowability of a computational repair advice. Thus, this invention provides a way to execute a well-posed mathematical method for determining the consistency of a mathematical model and the allowability of a computational request imposed on this consistent model, including, when required, providing advices for altering the model and/or altering the computational request.

### Description of Computer Programmed in Accordance with this Invention

As discussed above, the master program 14 is installed in the memory 12 of the computer 10, enabling the central processing unit 11 to execute automatically a well-posed mathematical method. As is depicted in FIG. 8, a human operator interfaces with the computer 10 through an interface control and display system 16. The interface control and display system 16 is conventional and may comprise a display monitor, keyboard, mouse, switches, voice command, scanner, punch cards, punch tape, magnetic tape, compact disc, digital video disk, optical inputs, etc. Through this interface control and display system 14, the human operator inputs to the computer 10 a proposed mathematical model, computational requests imposed on this model, choices on alternatives to repair either the model or a computational request, and the decision to activate the final, well-posed computational request. By this same means, the computer 10 provides to the human operator the status of the model's consistency or the allowability of a computational request, and any advice, if necessary, to repair the model or request.

The computer 10 receives from the human operator and stores in its memory 12 a mathematical model and computational requests. The computer 10 also stores and operates the master program 14. This program 14 includes the following subprograms:

1) a consistency subprogram 18,

2) a consistency repair advice subprogram 20,

3) a computation allowability subprogram 22,

4) a computation allowability repair advice subprogram 24, and

5) a computational request activation subprogram 26.

The structure, sequence and flow of these subprograms 18, 20, 22, 24, and 26 are as follows:

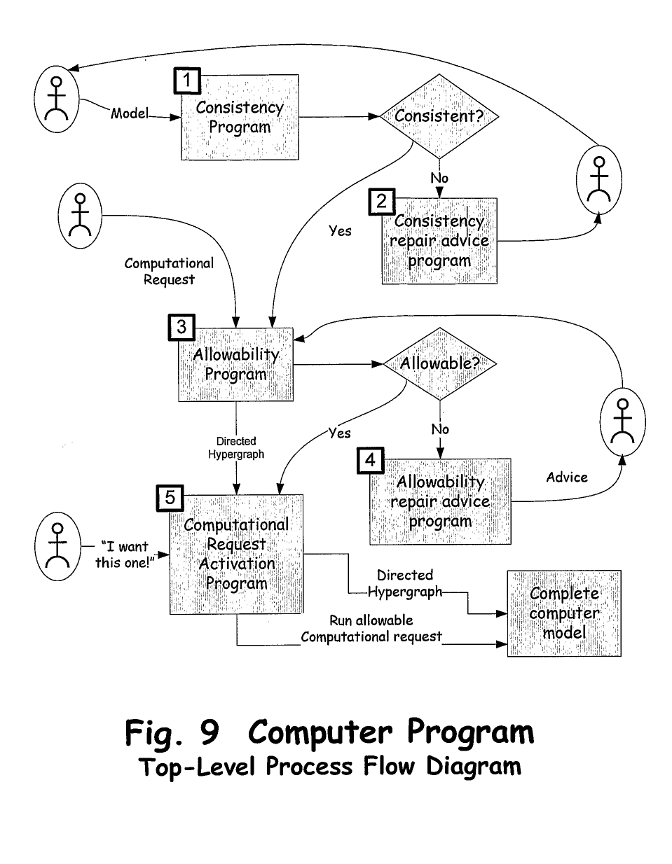

FIG. 9 1 illustrates the top-level logical sequence and flow of the subprograms 18, 20, 22, 24, and 26. The human operator inputs a proposed mathematical model into the computer memory 12 and it is transferred to both the consistency program 18 and computation allowability subprogram 22. The consistency program 18 automatically analyzes the model's consistency and, if consistent, hands off to the computation allowability subprogram 22, but if not consistent, hands off to the consistency repair advice subprogram 20. The consistency repair advice subprogram 20 develops and presents one or more alternative choices to the human operator to bring the model to consistency. After the human operator chooses an alternative, that is, a modified model, the consistency subprogram 18 cycles the modified model to assure consistency and hands off to the computation allowability subprogram 22 only if consistency of the modified model is confirmed. The computation allowability subprogram 22 automatically analyzes the allowability of the computational request, and if allowable, transfers a well-posed directed hypergraph (or companion matrix) to the activation subprogram 26 with the order to run the now well-posed computational request. If the computation allowability subprogram 22 determines that a computational request is not allowable, the computation allowability repair advice subprogram 24 develops and presents one or more alternative choices to the human operator to bring the computational request to allowability. The altered computational request is then cycled through the computation allowability subprogram 22. When allowability of the altered computational request is verified, the companion matrix, which is homomorphic to the directed hypergraph, is handed off to the activation subprogram 26. The activation subprogram 26 now produces the well-posed result of the computational request on the consistent model. The details of the subprograms 18, 20, 22, 24, and 26, and the logical sequence of each of these subprograms, are as follows:

### Consistency Subprogram

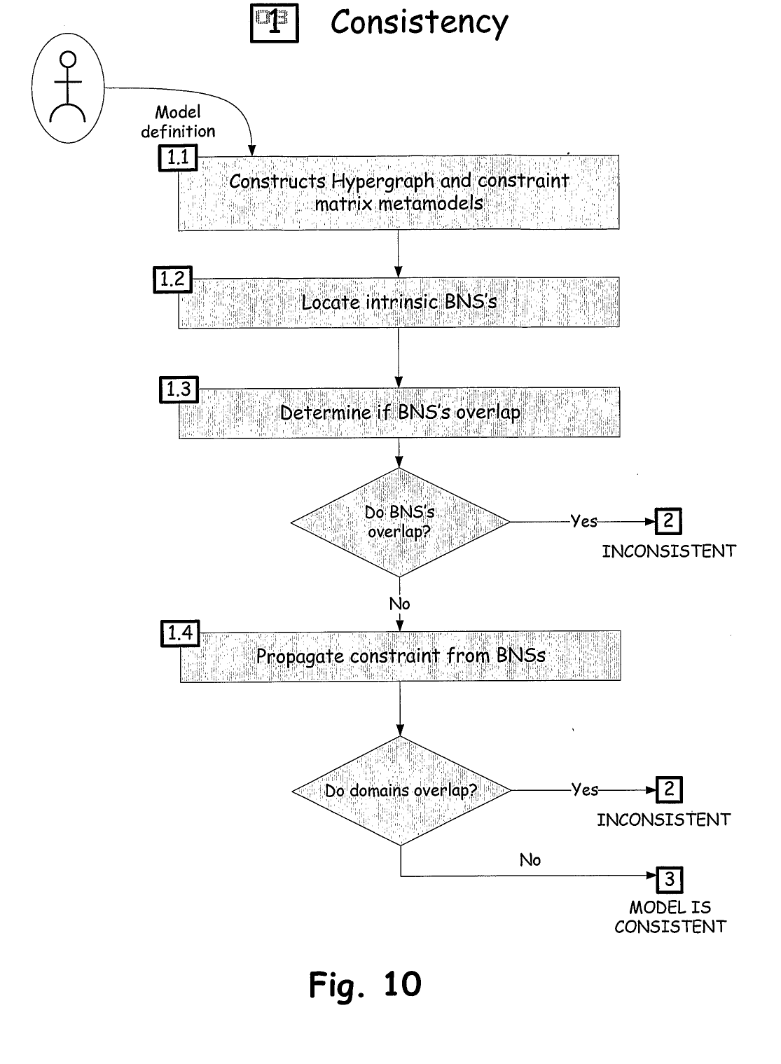

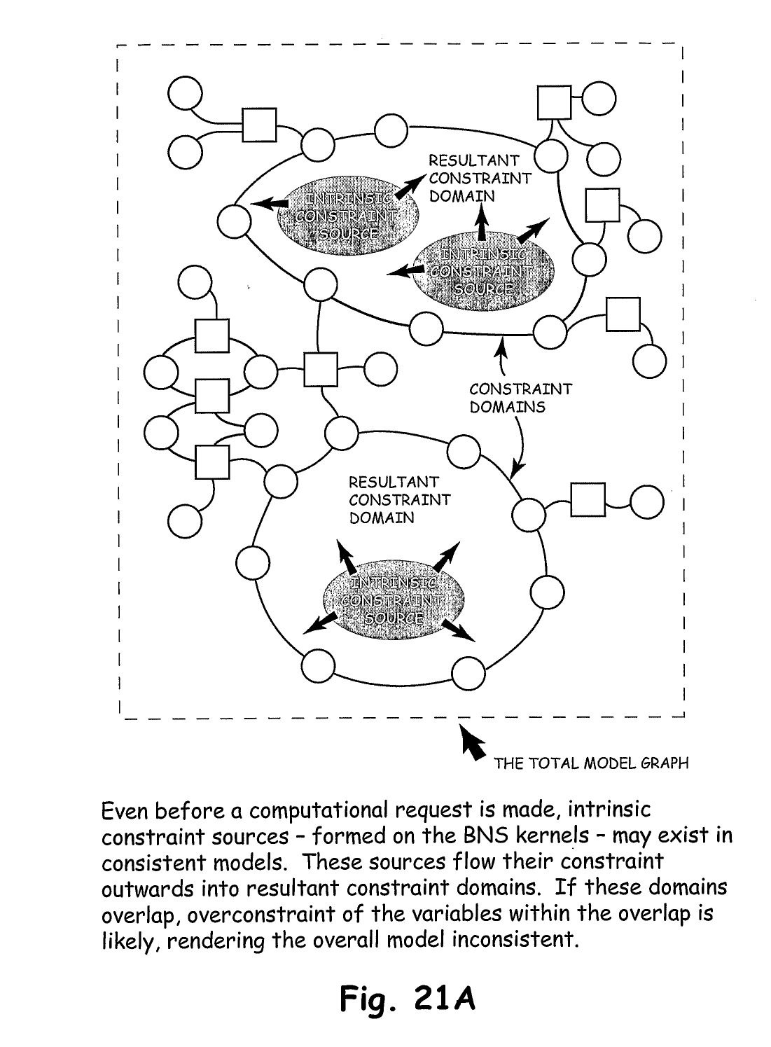

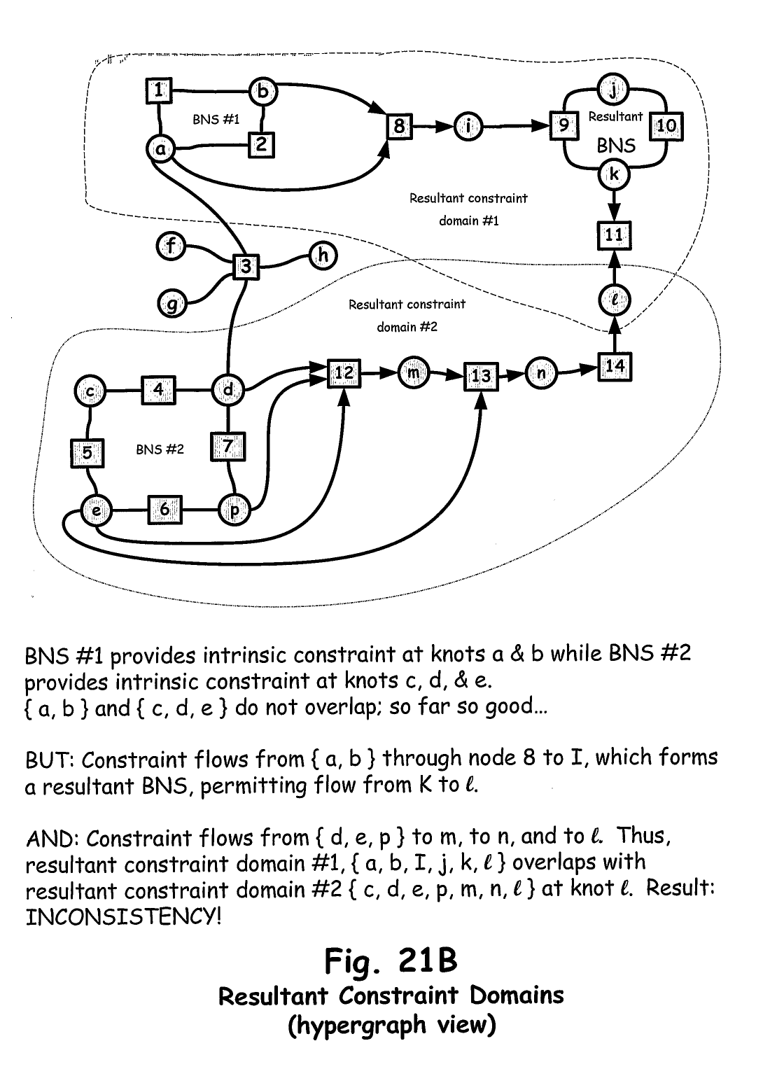

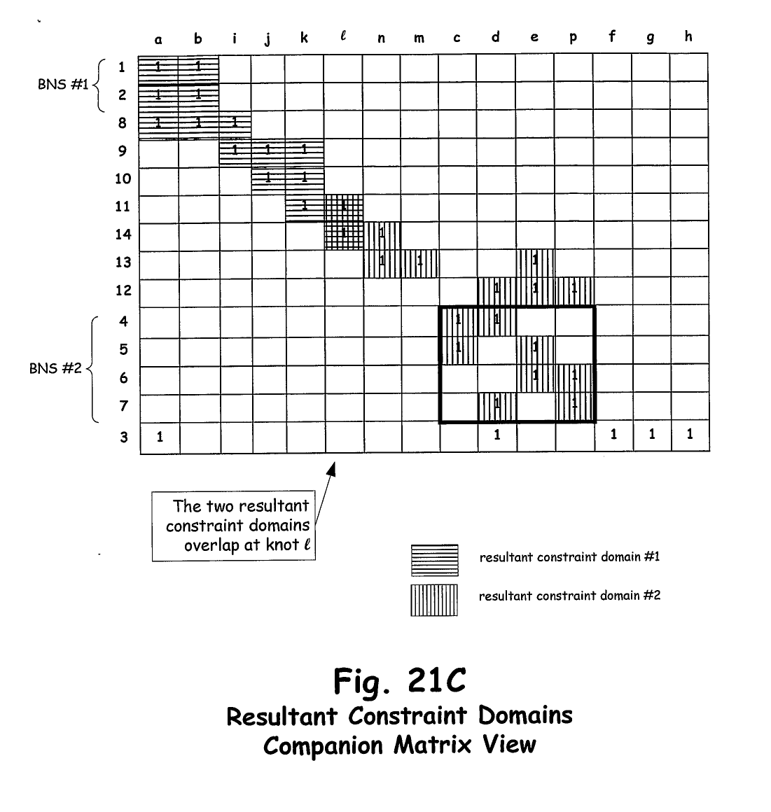

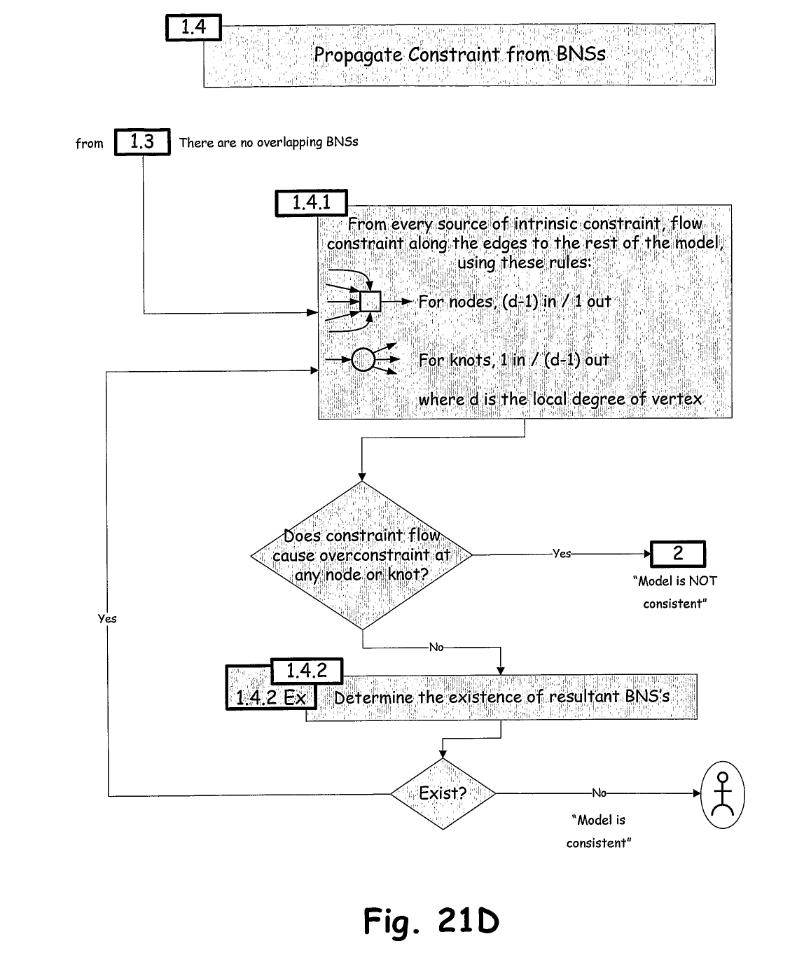

As illustrated in FIG. 10, once the human operator has provided the mathematical model to the computer 10, a hypergraph and companion metamodels are constructed by the consistency subprogram 18. Then any intrinsic basic nodal squares (BNS's) are located. Next, it is determined whether these BNS's overlap; that is, do the BNS's share common variables? If the answer is “yes”, then the model is inconsistent and the consistency subprogram 18 hands off to the consistency repair subprogram 20. If the answer is “no,” then constraint is propagated to the remainder of the mathematical model into larger constraint domains (FIGS. 21A through 21D). If these domains overlap, then the model is inconsistent and the consistency subprogram 18 hands off to the consistency repair subprogram 20. If these domains do not overlap, then the model is consistent and the consistency subprogram 18 hands off to the allowability subprogram 22.

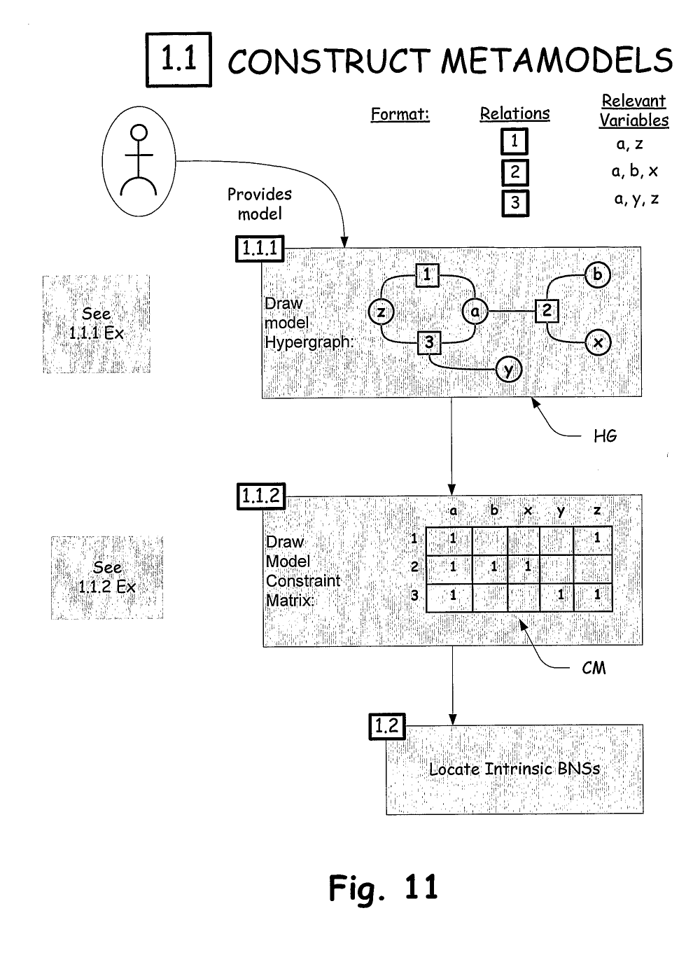

The process of constructing the metamodels is summarized in FIG. 11 which provides a simple illustration regarding the transferring of information inherent in a three (3) equation mathematical model having five (5) variables a, b, x, y, and z to the hypergraph HG and its companion matrix CM. The hypergraph HG is constructed by assigning a circle (or knot) to each variable and a square (node) to each equation, while indicating the relevancy of each variable to an equation by an edge. Equivalently, the companion matrix CM is constructed by assigning a row to each variable and a column to each variable, while indicating the relevance of a variable to an equation by a non-zero symbol in the cell corresponding to that variable and equation.

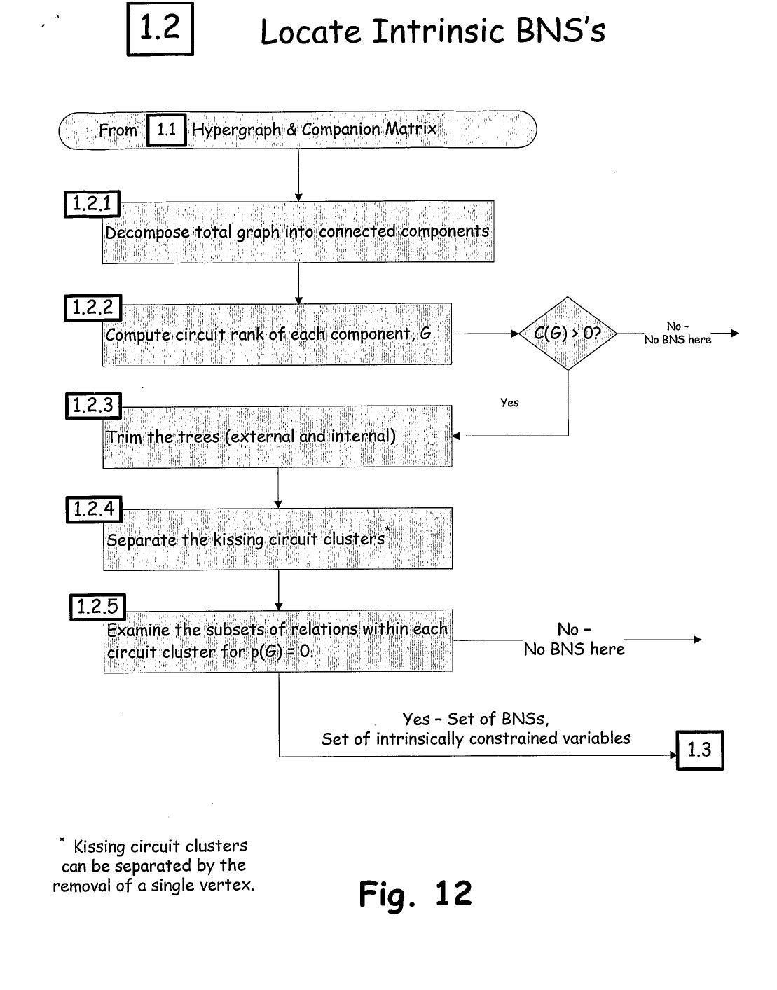

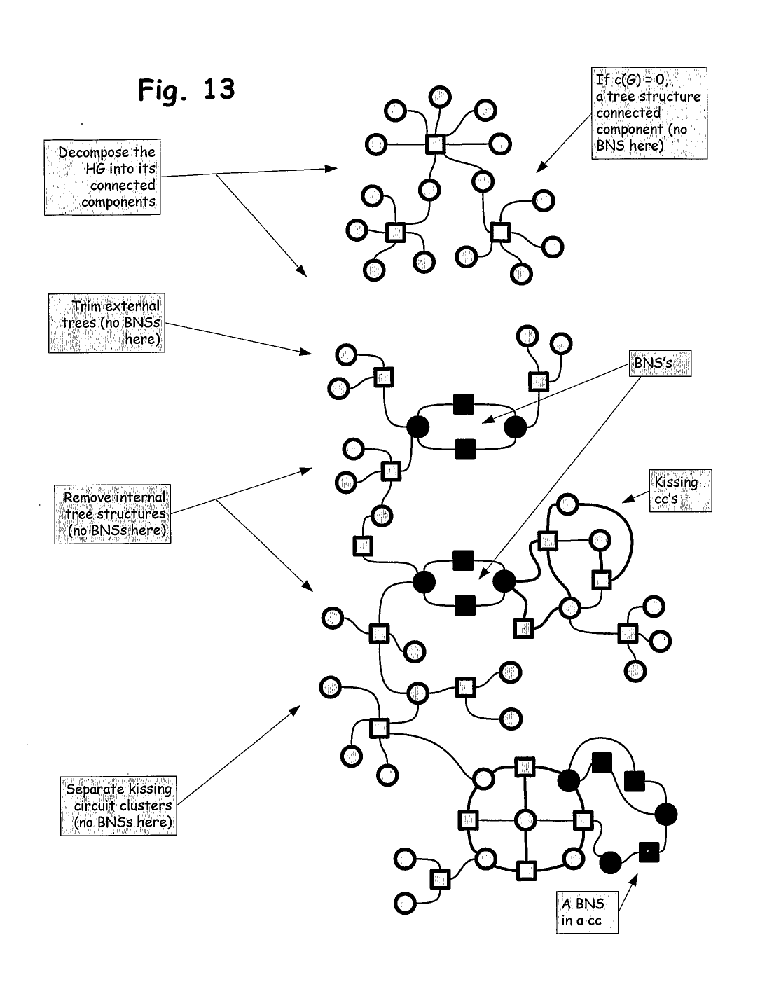

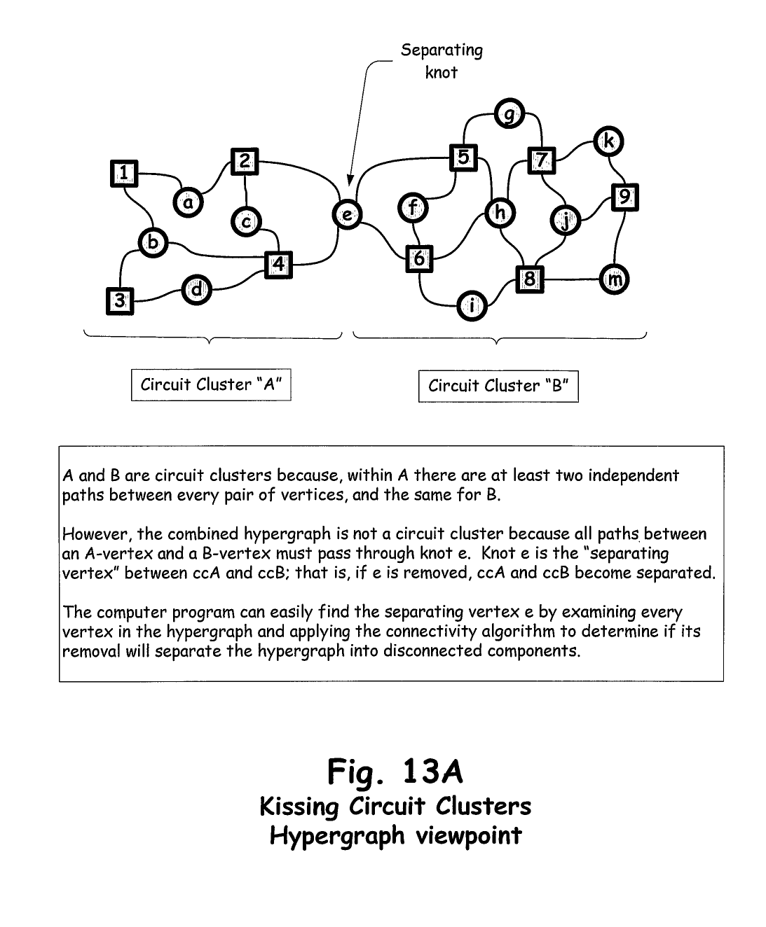

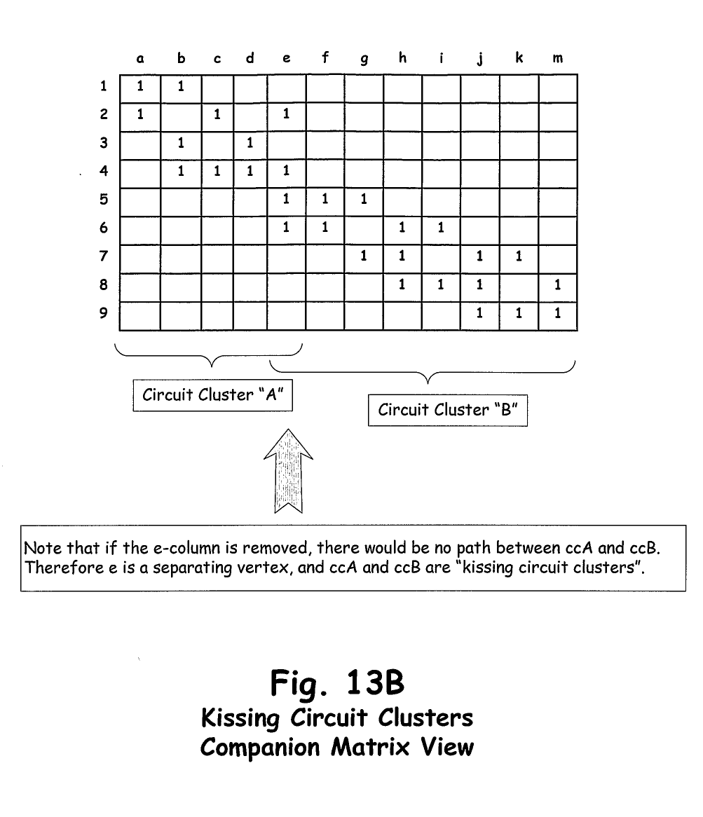

As shown in FIGS. 12 and 13, the routine that locates intrinsic BNS's relies on the fundamental mathematical principle that every BNS exists only within a circuit cluster. The consistency subprogram 18 locates any BNS's through a process of elimination by identifying hypergraph structures that cannot contain a BNS. The sequence of the routines for identifying circuit clusters is important. First, the total hypergraph is decomposed into its connected components. Second, within each connected component, the circuit rank is computed to determine the presence of tree structures. Only a connected component with a circuit rank greater then zero may possibly contain a BNS. Third, any tree structures attached to circuit clusters are temporarily suspended, leaving only circuit clusters and kissing circuit clusters. Forth, separating vertices are then temporarily suspended, resulting in only circuit clusters as depicted in FIGS. 13A and 13B. Fifth, sub-models within these circuit clusters are examined for zero constraint potential p(HG) to find any intrinsic nodal squares, and if they exist, for smaller nodal squares within the intrinsic nodal squares, repeating the examination of progressively smaller nodal squares until the smallest, a BNS, is identified.

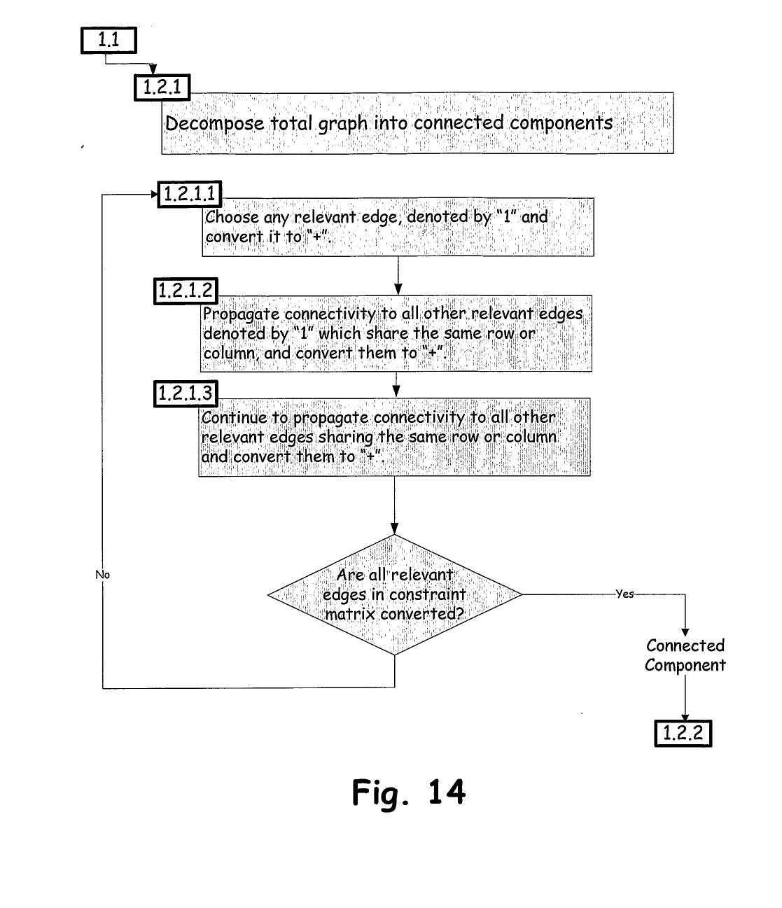

FIGS. 14 through 18 each individually illustrate the details of the series of routines depicted in FIGS. 12 and 14. As shown in FIG. 14, the first routine of the consistency subprogram 18, the decomposition of the total hypergraph into its detached components, initially calls for choosing at random any edge of the hypergraph (or non-zero cell of the companion matrix) as a starting point. Then connectivity is propagated from this starting point to all adjacent—or connected—parts of the metamodel until the propagation can go no farther. If every vertex of the metamodel has been reached, then the metamodel has been separated into its connected components: if not, then choose at random an unreached vertex and repeat the process until all vertices have been reached. The result is that the metamodel is decomposed into an exhaustive, and mutually exclusive set of connected components. From constraint theory, every BNS—if it exists—must be completely contained within a connected component.

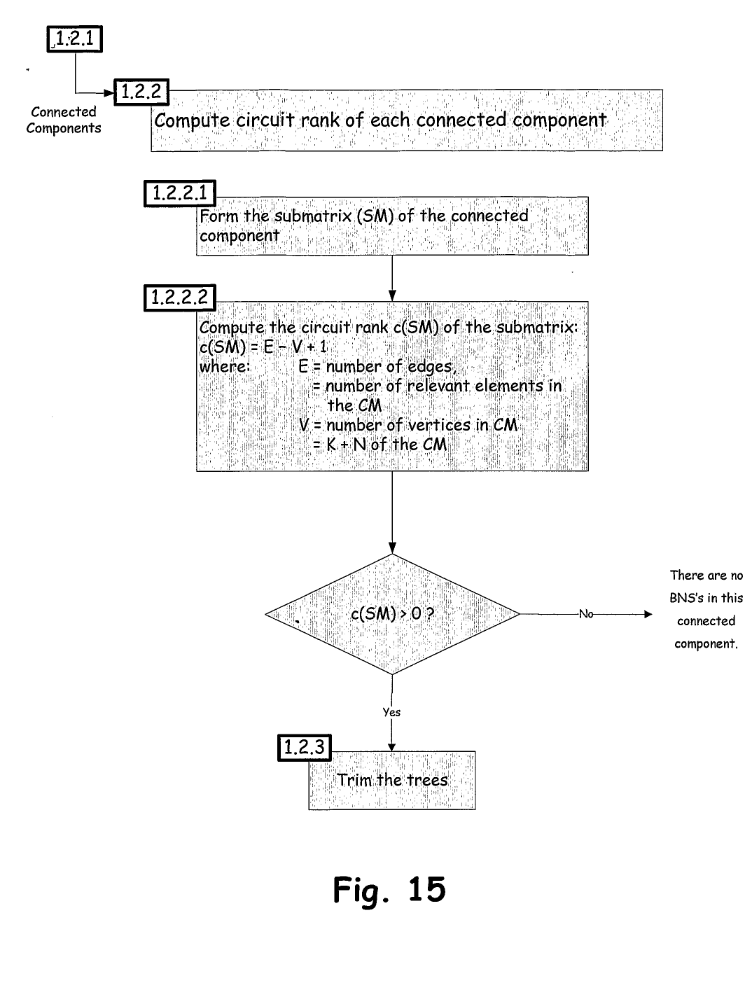

As illustrated in FIG. 15, in the second routine of the consistency subprogram 18, tree structures in each connected component are identified. To do this a routine computes the circuit rank in each connected component. If the circuit rank, (E−V+1), of a connected component is zero, then the connected component is a tree structure and—from constraint theory—there can be no BNS's in this connected component.

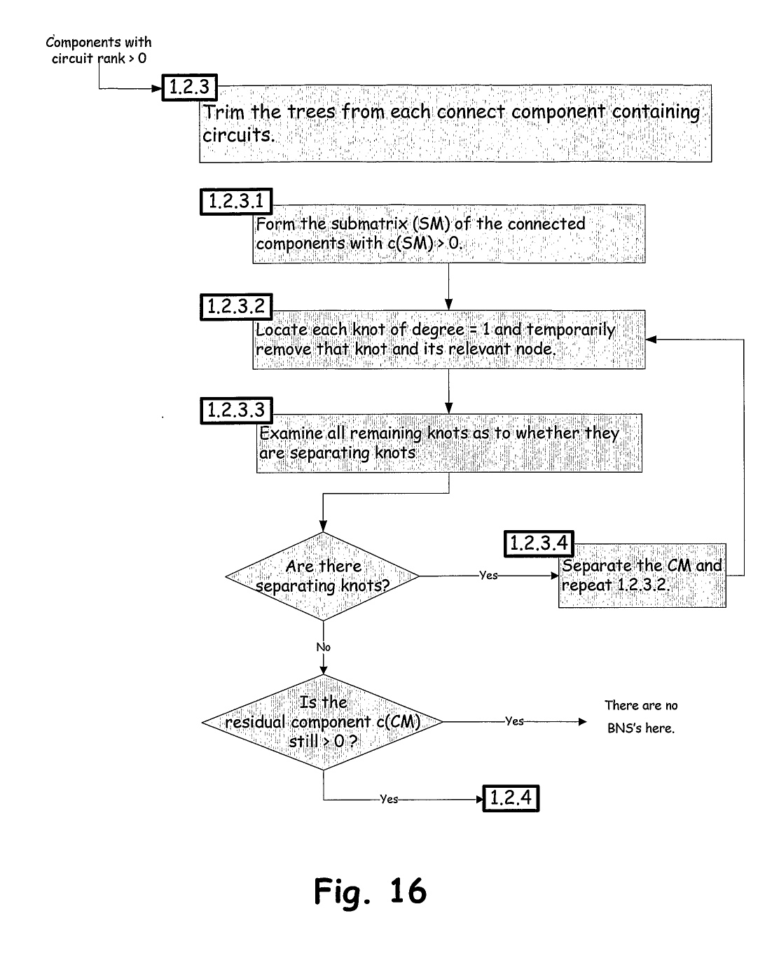

As illustrated in FIG. 16, for connected components with a circuit rank greater than zero, the third routine of the consistency subprogram 18 conducts a tree trimming process. This third routine of the consistency subprogram 18 first examines those connected components with a circuit rank greater than zero. These components are guaranteed to have circuit clusters, but they may also have tree structures—both external and internal. The external tree structures can be easily detected because they will terminate in “twigs”—vertices with a degree of one (or from the companion matrix viewpoint, solitary non-zero cells in either a row or column.) These “twigs” can be temporarily suspended, edge-by-edge, until the local structure no longer has a vertex with a degree of one. Internal trees can be detected by searching for separating vertices within the connected component. By temporarily suspending from analysis these separating vertices, internal trees and twigs are made external and the process described above for external tree structures can be repeated. From constraint theory, there can be no BNS in a component that contains a tree structure.

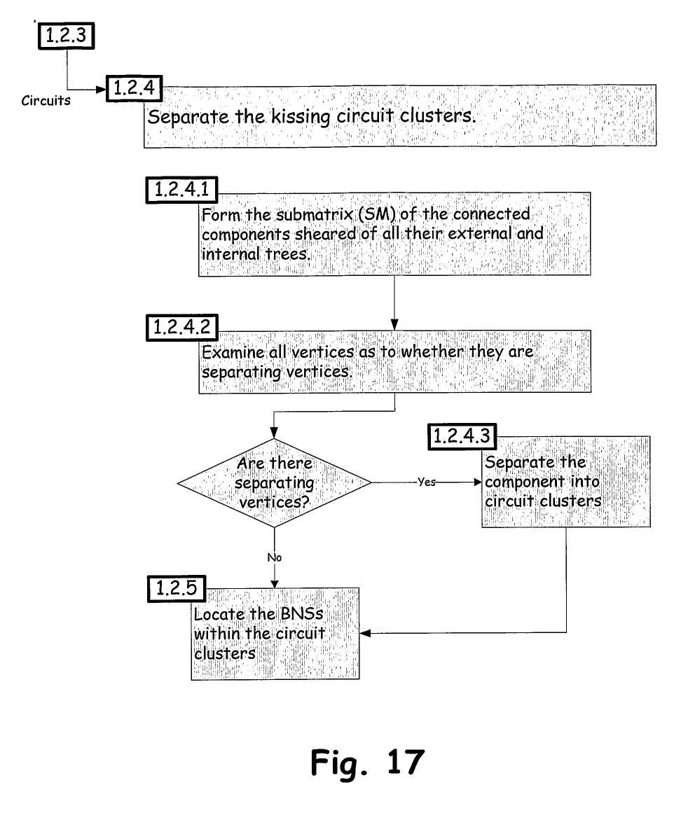

As illustrated in FIG. 17, the forth routine of the consistency subprogram 18 separates any kissing circuit clusters. After “tree-trimming,” all that that remains in a connected component being examined is a connected set of circuit clusters. Some of these circuit clusters may be connected only at a single vertex and are called “kissing circuit clusters.” These single vertices are separating vertices and can be detected by a separating vertex detection routine. A separating vertex can be detected by testing every vertex in the circuit clusters and then using the connectivity routine to determine whether any given vertex separates a circuit clusters into separated components as illustrated in FIGS. 13A and 13B. From constraint theory, no BNS can exist across kissing circuit clusters. What remains after separating kissing circuit clusters are circuit clusters.

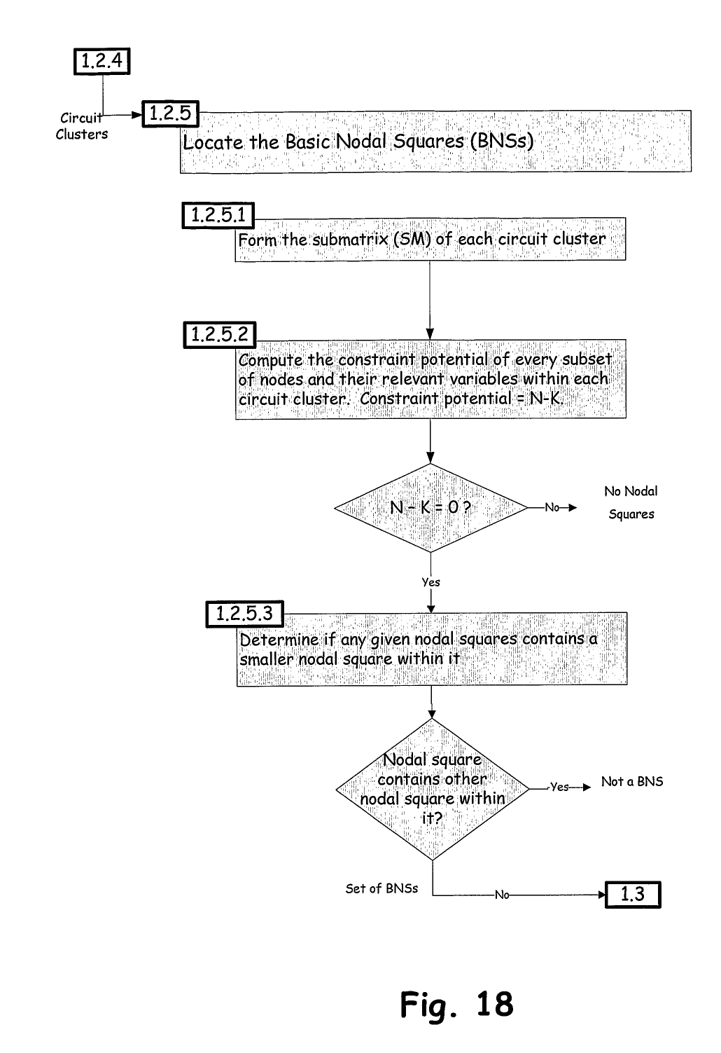

As illustrated in FIG. 18, the fifth routine of the consistency subprogram 18, locating BNS's, is executed only after all the components of a hypergraph (or its companion matrix) that do not permit the existence of a BNS have been eliminated, leaving one or more circuit clusters to be examined for a BNS. Every sub-model within each circuit cluster is examined for a constraint potential of zero—this yields the intrinsic nodal squares. Then every sub-model within each nodal square is examined for a possible smaller nodal square. When a nodal square is found which does not contain a smaller nodal square within it, a BNS is located. From constraint theory, each BNS is the source of intrinsic constraint—essentially each BNS is a “kernel of constraint.”

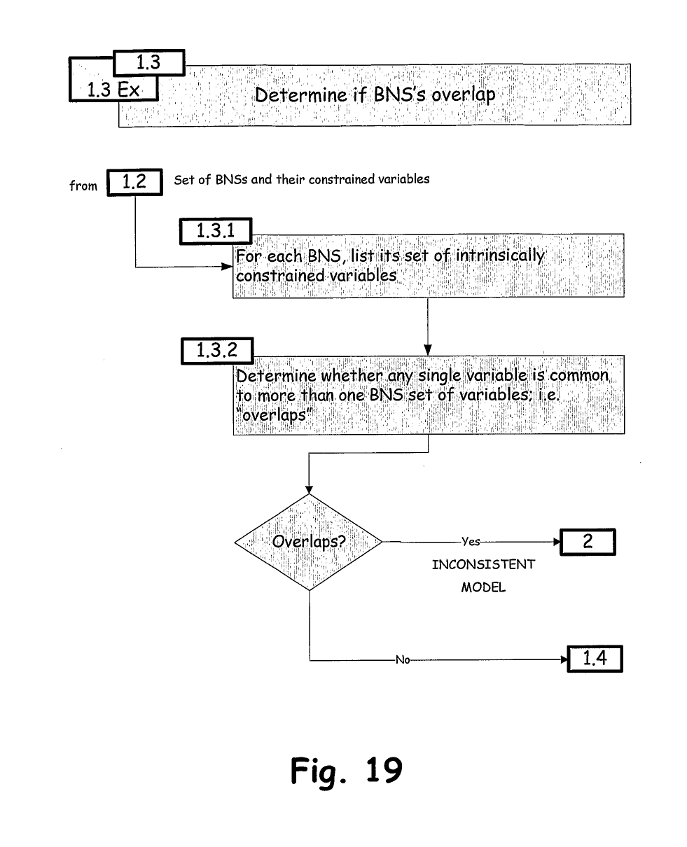

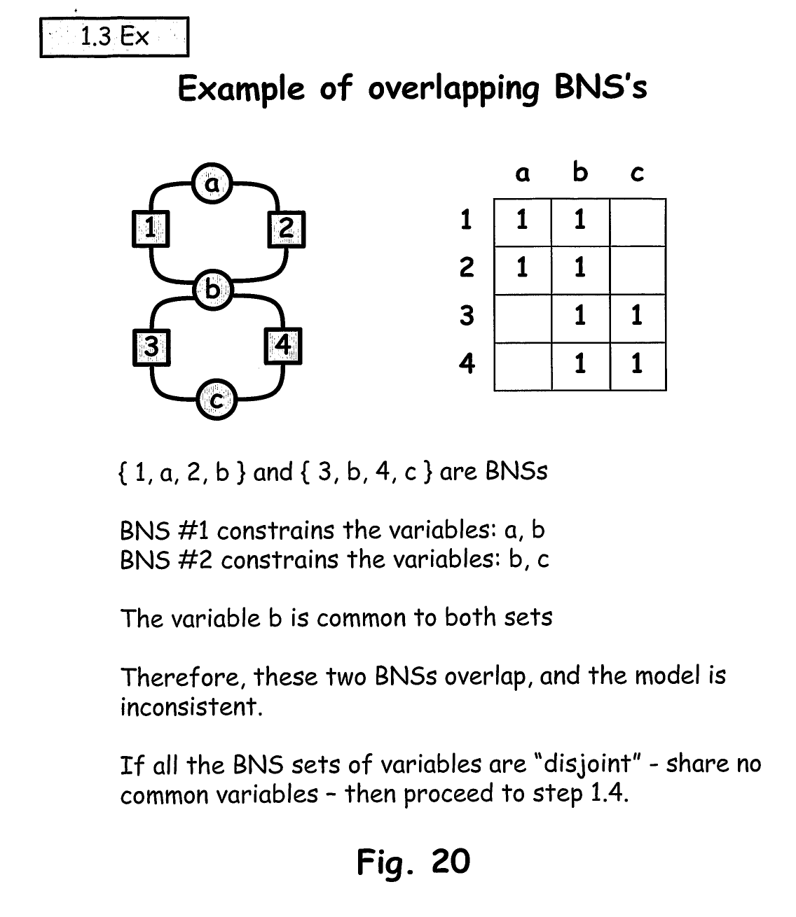

As illustrated in FIG. 19, once the BNS's—if they exist—have been located, the next routine of the consistency subprogram 18 to be executed is to determine whether the BNS's overlap. First, the set of variables that are relevant to each BNS are identified. Second, the routine compares these variables to determine whether any single variable is shared by two or more of the BNS's. If so, these variables are over-constrained and the model is inconsistent. FIG. 20 depicts a simple example of the BNS overlap process in a mathematical model with four equations numbered 1 through 4 and three variables a, b, and c.

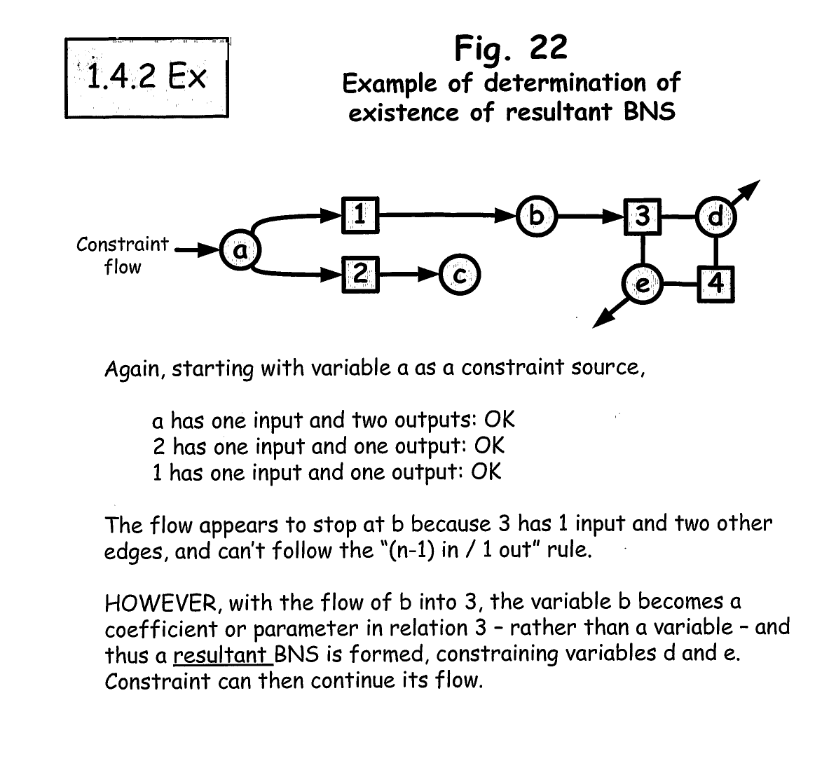

Even if the identified BNS's do not overlap, it is possible that the resultant constraint domains that emanate from the BNS's may overlap as depicted in FIG. 21B. Consequently, as illustrated in FIG. 21B, it is necessary to propagate constraint from the identified, non-overlapping BNS's. Accordingly, the consistency subprogram 18 interacting, for example, with the matrix illustrated in FIG. 21C, now executes its final routine to identify any resultant constraint domains. In doing this, the constraint propagation rule for tree structures is employed to determine the resultant constraint domains, namely: For nodes, (dᵥ−1) in allows 1 out. For Knots, 1 in allows (dᵥ−1) out. If these domains overlap, then the model is inconsistent. When any resultant constraint domain expands to the vicinity of identified circuit clusters, then the existence of resultant BNS's—which serve to further expand the constraint domain—becomes a factor. FIG. 22 depicts the formation of such resultant BNS's.

If there are no overlapping BNS's, and if their resultant constraint domains do not overlap, then it can finally be concluded that the model is consistent. The program 14 now proceeds to the computational allowability subprogram 22 for execution; otherwise, the consistency repair advice subprogram 20 must be employed to advise the human operator of his or her options to repair the proposed, inconsistent mathematical model.

### Consistency Repair Advice Subprogram

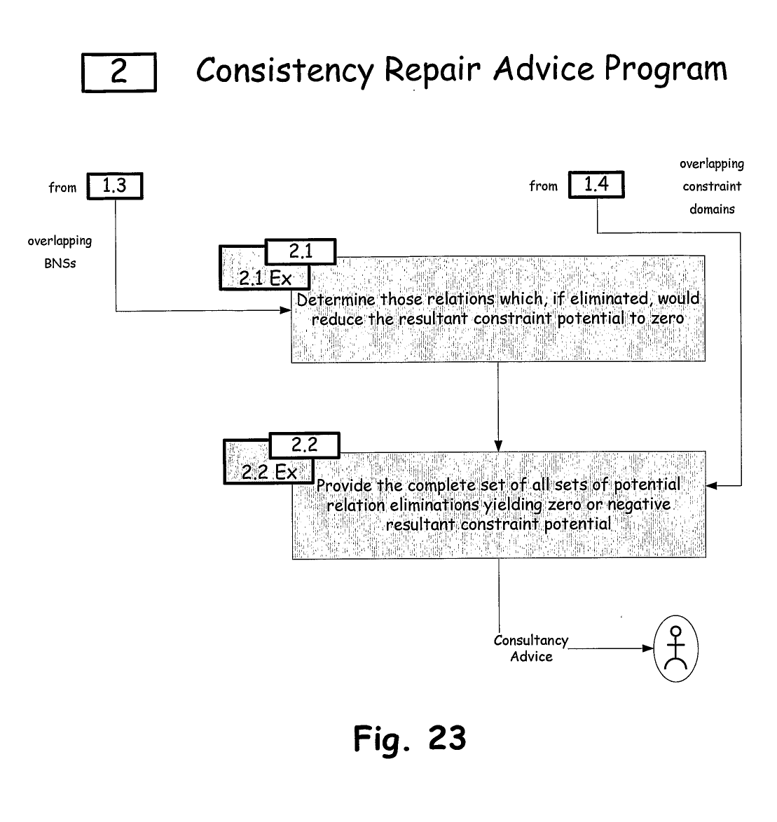

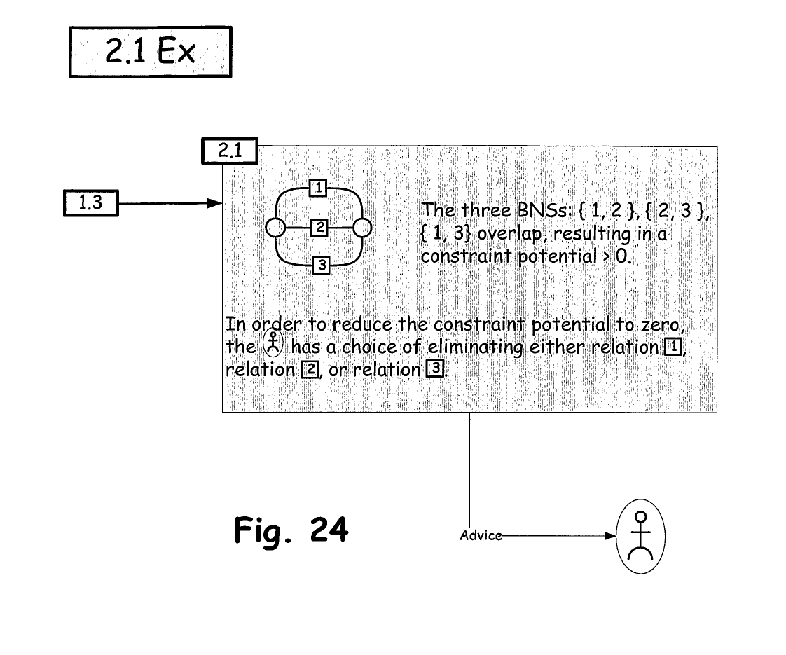

If the consistency subprogram 18 determines that the model, as proposed by the human operator, is inconsistent, then the consistency repair advice subprogram 20 is employed to suggest one or more alternative or modified models to the human operator for bringing the proposed mathematical model to consistency. As illustrated in FIG. 23, the first routine executed by the consistency repair advice subprogram 20 examines any identified overlapping BNS's and determines which equations, if eliminated, would reduce the resultant constraint potential to zero. As illustrated in FIG. 24, three (3) overlapping BNS's have been identified upon executing the first routine and the human operator is advised to eliminate one of the equations—nodes 1, 2 or 3.

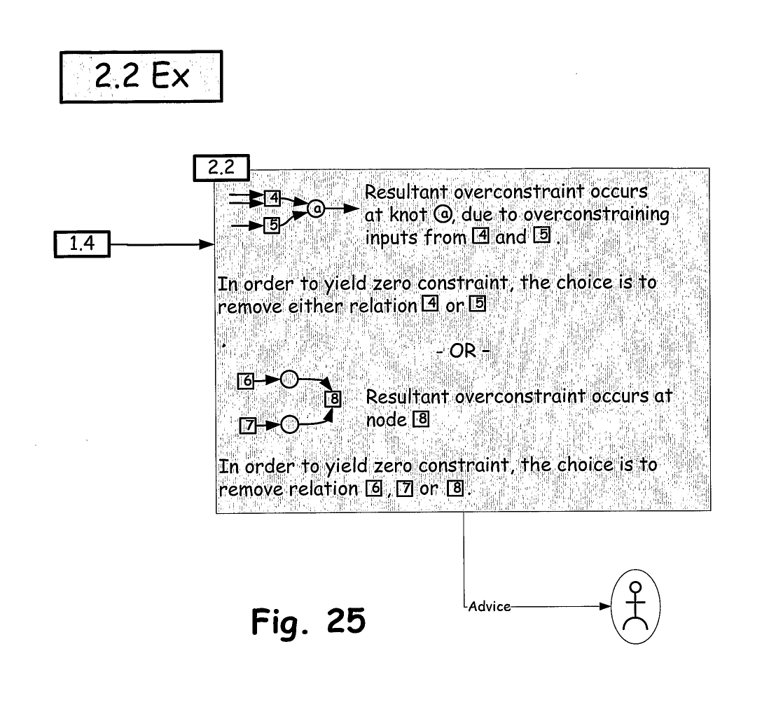

As is shown in FIG. 25, over-constraint can occur at either a knot or a node, and the consistency repair advice subprogram 20 identifies those equations that reduce the constraint potential to zero or less, or it identifies constants within the equation which can be converted to variables. In this illustration, it is one of the equations—nodes 6, 7 or 8. The consistency repair advice subprogram 20 forwards to the human operator a repair advice message displayed or otherwise presented to the human operator by the interface control and display system 16. The human operator—usually in collaboration with the technical team that constructed the original (proposed) version of the mathematical model—chooses one of the advisory alternatives, rendering the model consistent.

### Computational Allowability Subprogram

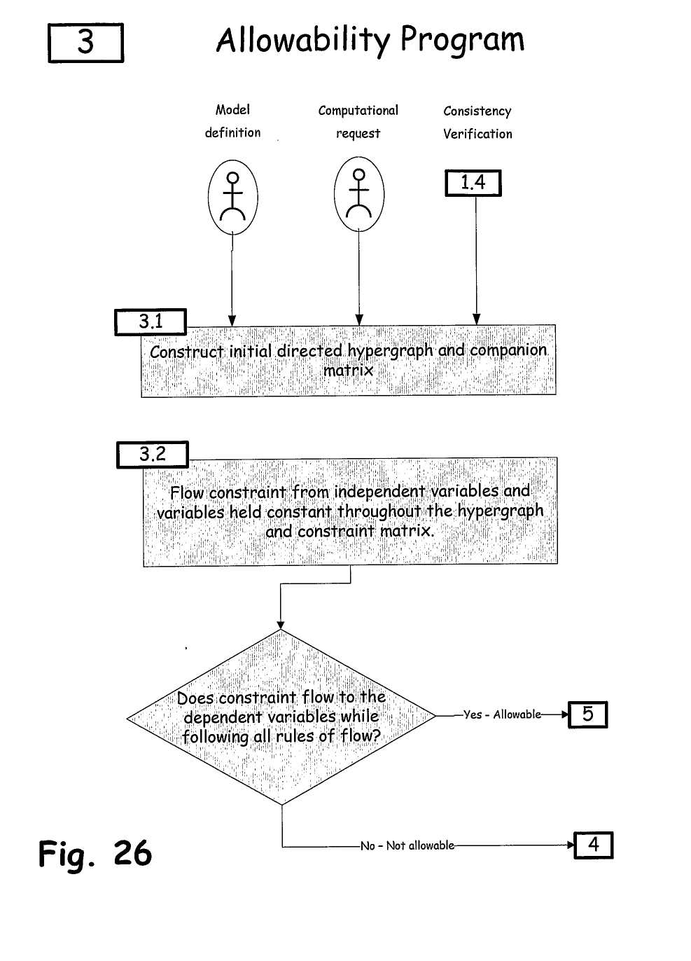

Once the mathematical model is consistent, or made to be consistent, then the next major routine is executed to determine the computational allowability of a computational request. As is shown in FIG. 26, the first routine executed by the computational allowability subprogram 22 is to construct a metamodel of the mathematical model—corrected if necessary according to the advice provided by the consistency repair advice subprogram 22—and identify the independent variables, any variables held constant, and the dependent variable of the specific computational request.

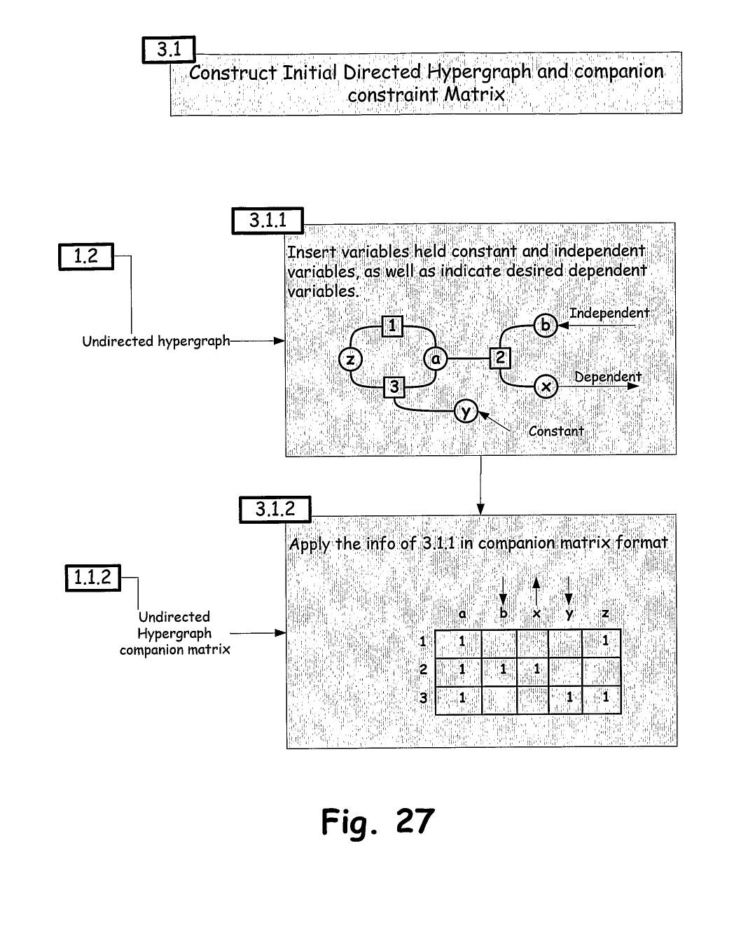

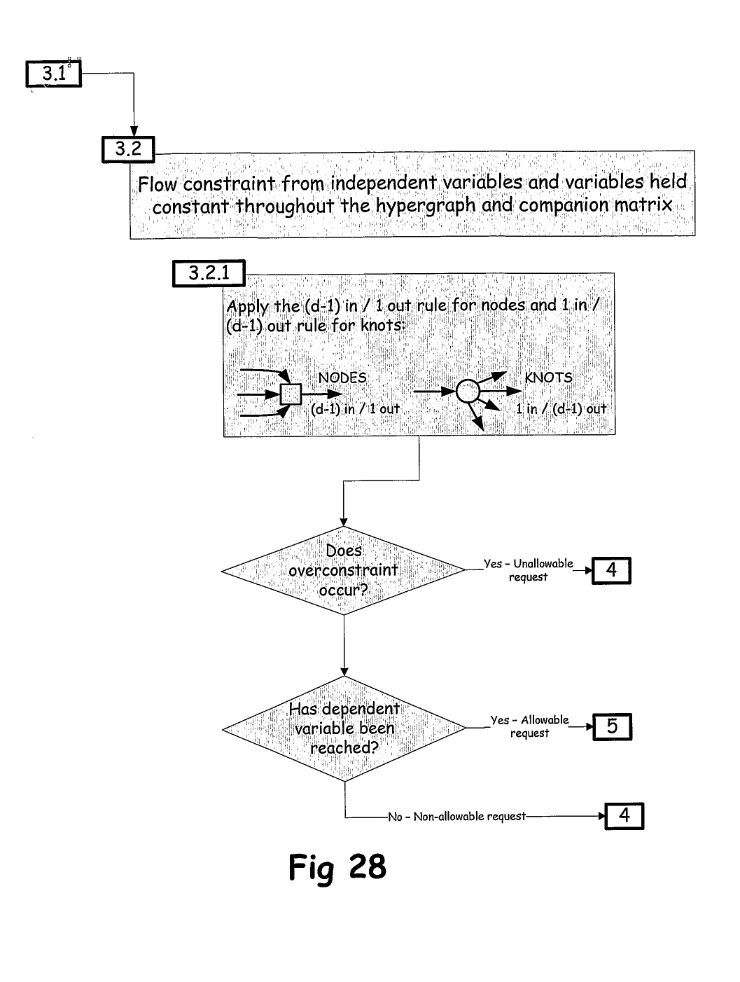

FIG. 27 depicts how a directed hypergraph and companion matrix represent a computational request, and FIG. 28 recapitulates the rule for constraint flow in tree structures. If the resultant constraint potential equals exactly zero along the entire path from the independent variables and any variables held constant to the dependent variable, then the computational request is allowable. If the resultant constraint potential anywhere along the path is less than zero, the computation is under-constrained. If the resultant constraint potential anywhere along the path is greater than zero, the computation is over-constrained. In either case the computational request is not allowable. (It is possible for a single computational request to be both over- and under-constrained, at different points along the computational path.) If the computational request is not allowable, then the computational allowability repair advice subprogram 24 is executed.

### Allowability Repair Advice Subprogram

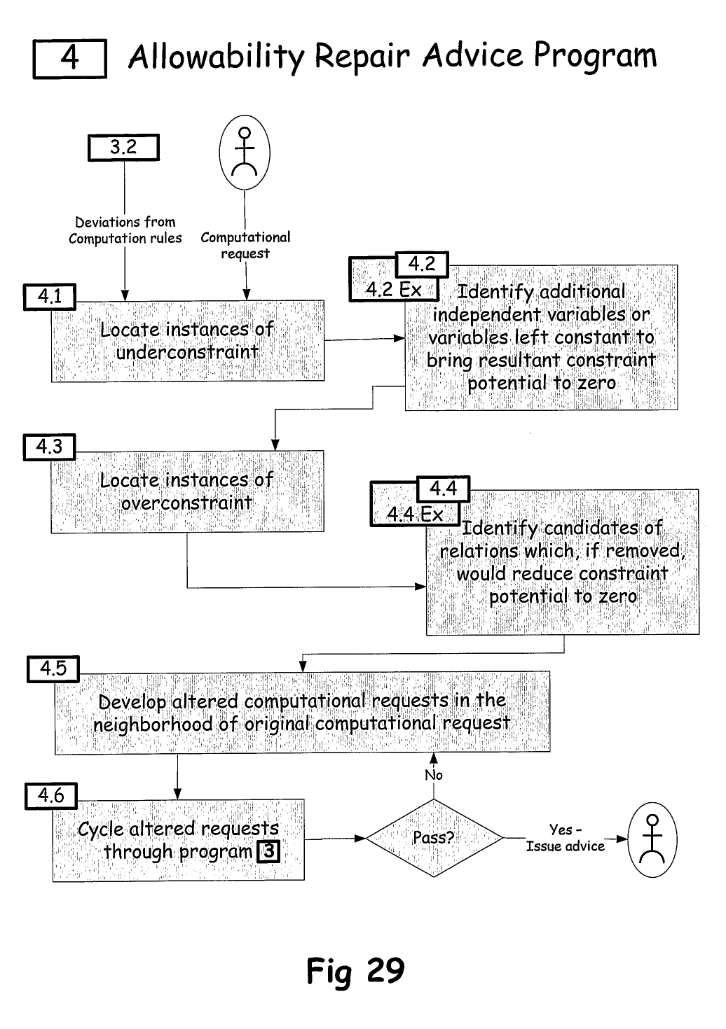

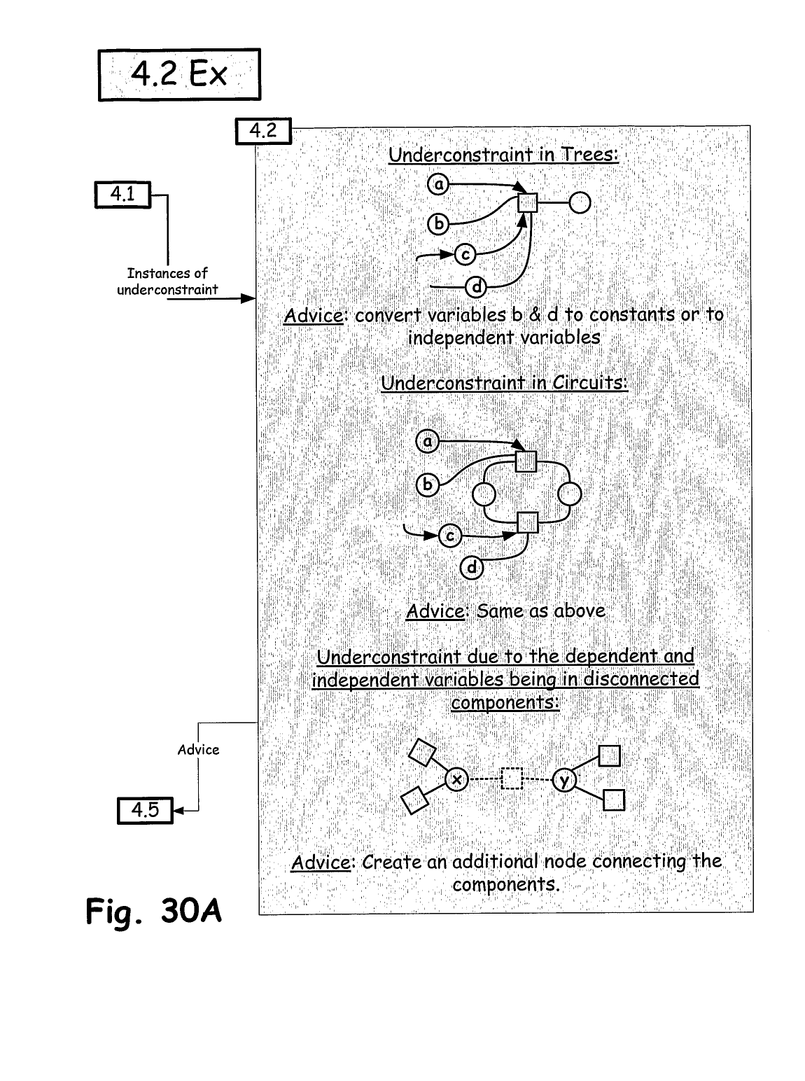

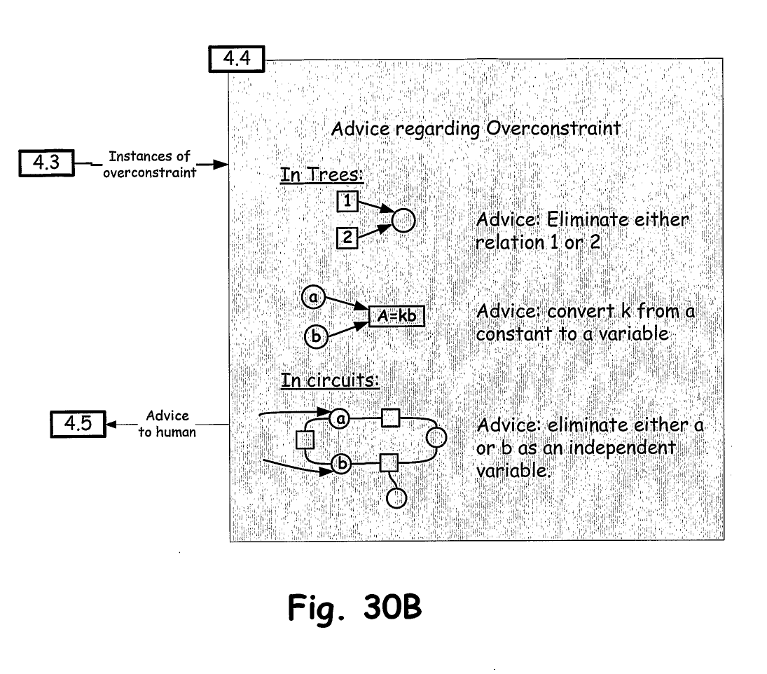

When the computational allowability subprogram 22 determines that a computational request is not allowable, then the computational allowability repair advice subprogram 24 is executed as depicted in FIG. 29. If the computational allowability program 22 concludes that the computation is under-constrained at certain vertices and circuit clusters along the computational path, the computational allowability repair advice subprogram 24 identifies additional independent variables or constants at those vertices to bring the resultant constraint potential p(HG) up to zero. If the computational allowability subprogram 22 concludes that the computation is over-constrained at certain vertices along the computational path, the computational allowability program 22 identifies equations which—if removed—or constants which could be converted to variables, would reduce the resultant constraint potential to zero. If the variables in the computational request lie in disconnected or detached components, then the repair program will provide an advice suggesting the addition of one or more nodes to provide a computational bridge between the components. FIG. 30A depicts the execution of the allowability repair advice subprogram 24 to provide an advice in the case of under-constraint. FIG. 30B depicts the execution of the allowability repair advice subprogram 24 to provide an advice in the case of over-constraint. Variables can be converted to constants, and additional nodes can be added in order to bring the resultant constraint potential up to zero.

In either case, the computational allowability repair advice subprogram 24 forwards to the human operator a repair advice message suggesting how to modify the computational request or modifying the model. The interface control and display system 16 displays or otherwise presents the message to the human operator. The output from the execution of computational allowability repair advice subprogram 24 includes a directed hypergraph with its companion matrix that will direct algorithmic sequencing and directional flow of the final computational request executed by the computational request activation subprogram 26.

### Computational Request Activation Subprogram

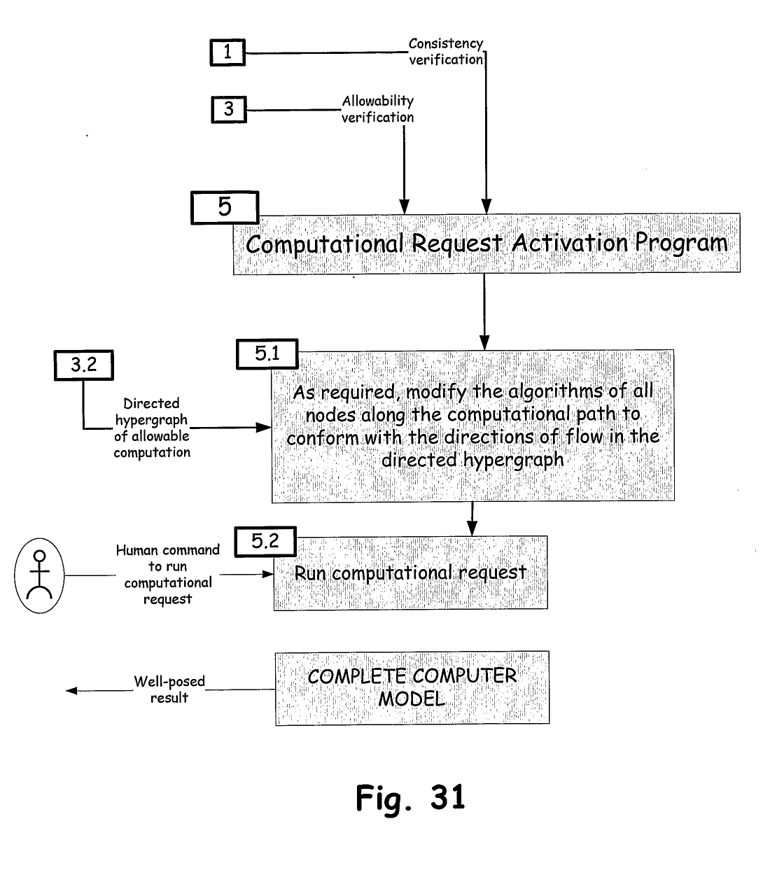

Finally, when both model consistency and computational allowability have been confirmed, the human operator is able to activate the computational request activation program 26, since he or she can be assured that the model and computations are well-posed. As illustrated in FIG. 31, the computational request activation program 26 employs a directed hypergraph created by the computational allowability subprogram 22. The actual computational path and ordering of algorithms will not be obvious, so the directed hypergraph with its companion matrix will direct the algorithmic sequencing. In general, the final, well-posed computational path, ordering of routines, and computational direction within each equation is not predictable; however, the directed hypergraph can serve to direct the programming task unambiguously.

The final result of the execution of the master program 14 by the central processing unit 11 is the well-posed management of the mathematical model—which is consistent—and a computation—which is allowable.

### Example

The following illustrates the use of the computer 10 where the human operator has entered into the computer's memory 12 the mathematical model shown in Table 1. A human operator using the computer 10 programmed as discussed herein to test this mathematical model for consistency and allowability of computational request.

### Mathematical Model

Table I lists a set of equations numbered 1 through 12 that comprise a mathematical model including the variables identified by the Roman letters a through u. Each equation, and any combination of individual equations, is a sub-model of the model of Table I.

TABLE I

| | |
|---|---|
| 1 | a = b + c |
| 2 | d = c³ |
| 3 | f = c − e⁵ |
| 4 | h = gi |
| 5 | j = 2g + h + 3i |
| 6 | k = j³ |
| 7 | j = 5k + k³ − 9k⁵ |
| 8 | j = 135sin³k |
| 9 | p = mj − 3l |
| 10 | l = 3p^{m}k |
| 11 | m = q + 5r^{q} |
| 12 | k = stu |

In this mathematical model the variables a, b, c, d, e, f, g, h, i, j, k, l, m, p, q, r, s, t, and u may each represent, for example, total program cost, development cost, operational cost, maintenance cost, return on investment, probability of mission success, weight, range, payload, response time, reliability probability, mean time between failures, failure rate, probability of survival, maneuverability, distance, velocity, acceleration, pitch angle, roll angle, yaw angle, or other dependent and independent variables. This model consists of 12 equations and 19 variables, and it is unlikely that the intrinsic constraint and the allowability of computational requests imposed on this mathematical model can be easily recognized without the techniques of constraint theory as applied using the computer of 10 this invention.

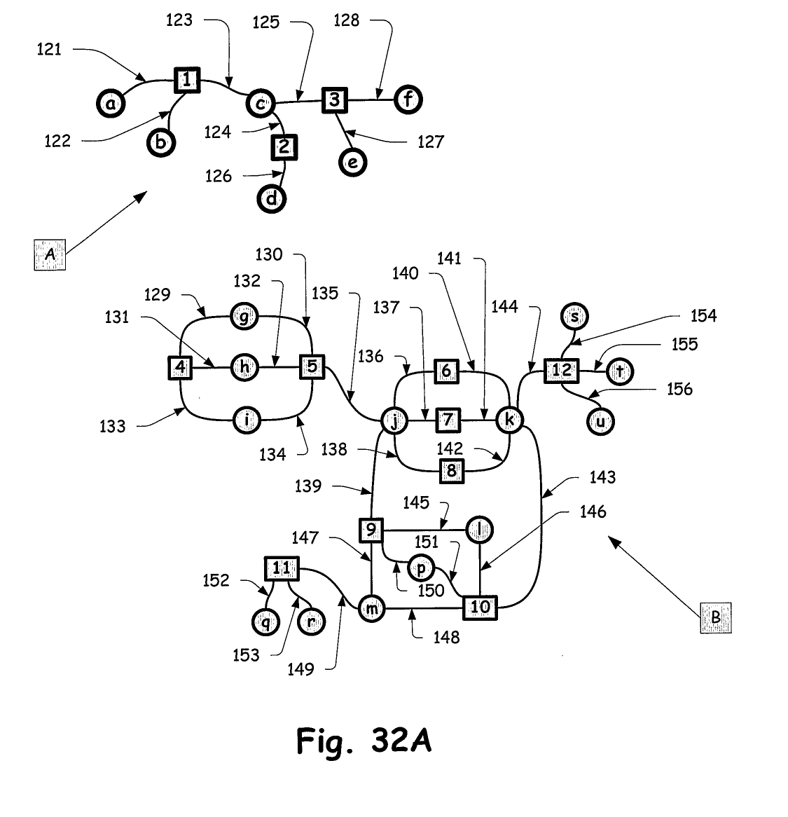

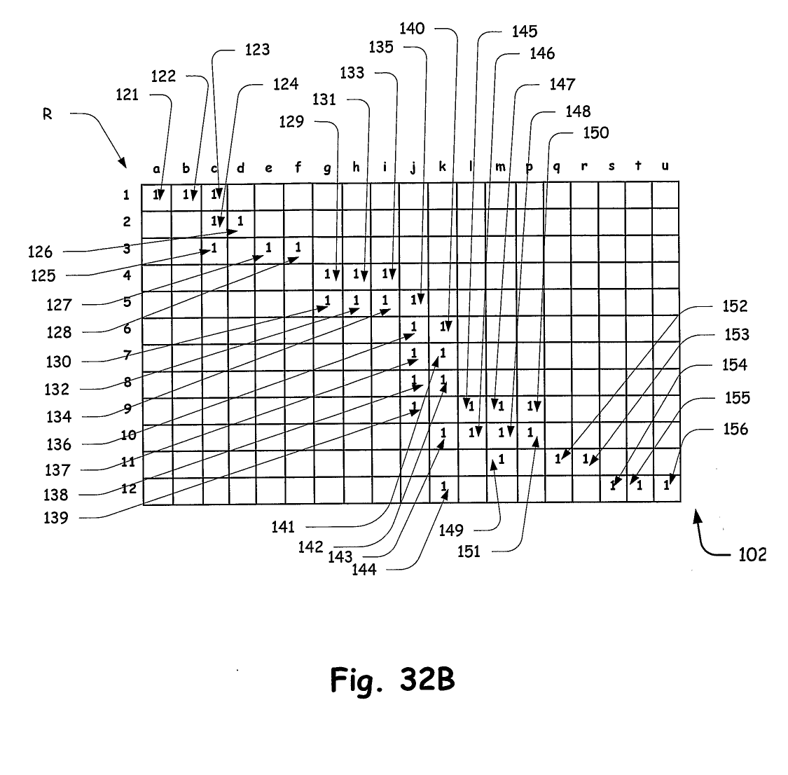

The hypergraph 102a of the mathematical model of Table I is shown in FIG. 32A and its companion matrix 102b is shown in FIG. 32B. The following Table II lists each edge of the model identified by the numerals 121 through 157 in the hypergraph 102a, and the corresponding nodes (equations) and knots (variables) to which they connect. As depicted in FIG. 32B, each edge corresponds to a cell of the matrix 102b, and the same numerals 121 through 157 identify the cells that correspond to the edges in the hypergraph 102a. The upper left hand corner cell is mark R may be used as a reference cell that enables the program 14 to start at this cell R and locate the information contained each other cell of the matrix 102b as required to run the program's various routines. This Table II is stored in the memory M of the computer 200 and may be accessed by the master program 14 in analyzing the matrix 102b as it runs its various routines.

TABLE II
Edge List

| Cell No. | Variable | Equation |
|---|---|---|
| 121 | a | 1 |
| 122 | b | 1 |
| 123 | c | 1 |
| 124 | c | 2 |
| 125 | c | 3 |
| 126 | d | 2 |
| 127 | e | 3 |
| 128 | f | 3 |
| 129 | g | 4 |
| 130 | g | 5 |
| 131 | h | 4 |
| 132 | h | 5 |
| 133 | i | 4 |
| 134 | i | 5 |
| 135 | j | 5 |
| 136 | j | 6 |
| 137 | j | 7 |
| 138 | j | 8 |
| 139 | j | 9 |
| 140 | k | 6 |
| 141 | k | 7 |
| 142 | k | 8 |
| 143 | k | 10 |
| 144 | k | 12 |
| 145 | l | 9 |
| 146 | l | 10 |
| 147 | m | 9 |
| 148 | m | 10 |
| 149 | m | 11 |
| 150 | p | 9 |
| 151 | p | 10 |
| 152 | q | 11 |
| 153 | r | 11 |
| 154 | s | 12 |
| 155 | t | 12 |
| 156 | u | 12 |

### Determining Model Consistency

Step 1: Using the connectivity routine discussed above, the master program 14 first analyzes the matrix 102b and determines that the model after removal of equation 7 of Table I consist of two sub-models: one identified by the letter A (FIG. 32A) consist of the equations 1, 2, and 3 and the other identified by the letter B consist of the equations 4, 5, 6, 7, 8, 9, 10, 11, and 12. As depicted in FIGS. 32A and 32B, each of these sub-models is a connected component, but they are detached from each other.

As can be easily seen from the hypergraph 102a (FIG. 32A), every pair of vertices (nodes or knots) within each of these two connected components A and B have at least one path connecting the equations and variables of each individual connected component, but there exists no path which connects the connected component A to the other connected component B. As shown in FIG. 32B, although somewhat less apparent, the companion matrix 102b also rigorously displays the same result. For example, it is seen that vertex j is directly connected to vertices 5, 6, 7, 8 and 9 and the connectivity continues from vertex 9 to vertices l, m and p. Furthermore, the first three rows (1, 2, and 3, representing the connected component A) of the matrix 102b provide no path of connectivity to the remainder of the matrix 102b; indicating rigorously that it is a connected component that is detached from the remainder of the model of Table I, namely, the connected component B.

Step 2: The program 14 next employs a routine that computes separately the circuit rank (CR) of each connected component A and B using the formula: circuit rank=CR=E−V+1. (V=number of nodes N plus number of knots K; E=the number of edges, also the number of cells marked with a symbol such as a slash (/) of each connected component). Although a slash (/) is used in this Example I, any suitable identification of cells corresponding to edges is acceptable.

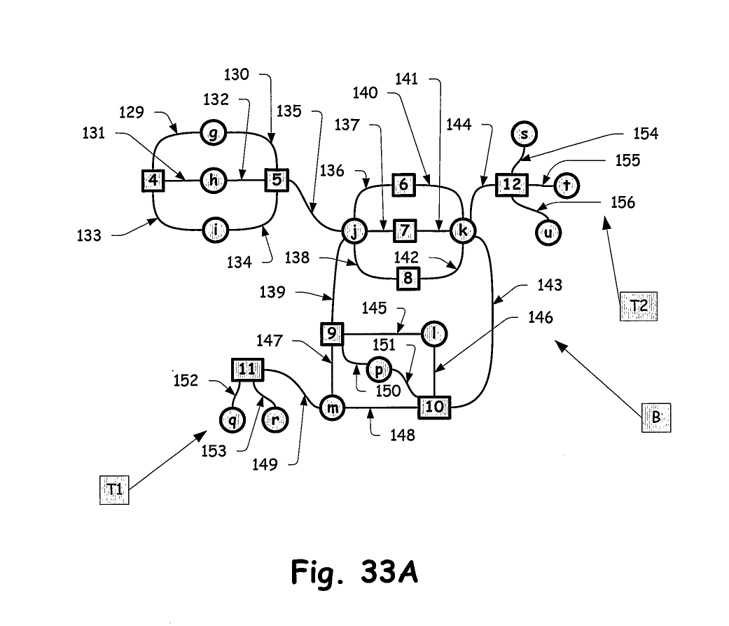

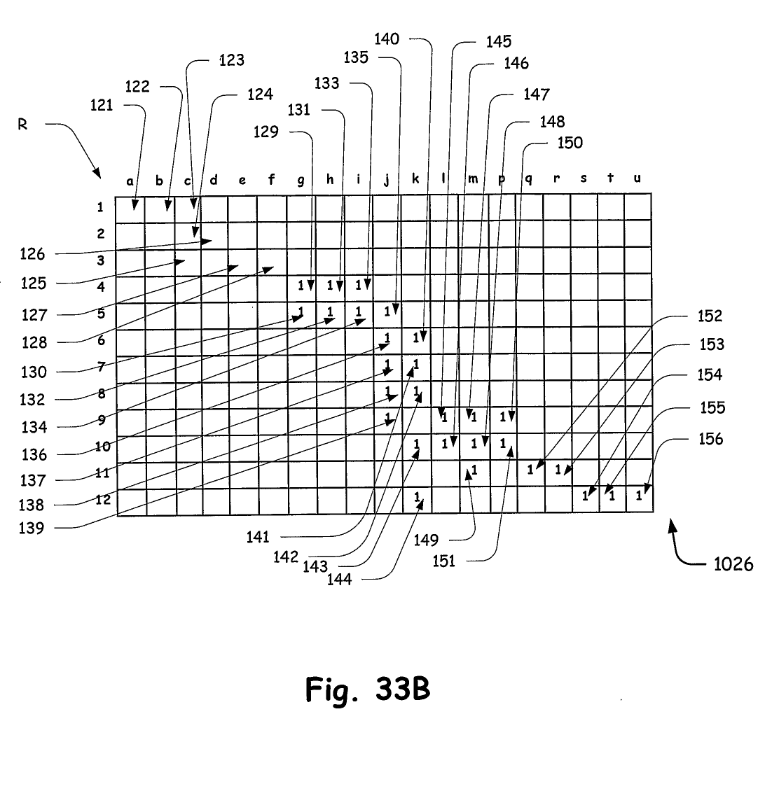

The routine computing circuit rank determines that the circuit rank of the connected component A equals zero, where E=8 and V=9. The circuit rank of the connected component B equals 7, where E=28 and V=22. This computation for the connected component B is equally easy using either the hypergraph 102a or the matrix 102b. For the hypergraph 102a, E is the number of edges and V is the sum of the number of nodes and knots (vertices). For the matrix 102b, E is the number of cells marked with a slash (/), namely, the cells 129 through 156, corresponding to the cells of connected component B, and V is the sum of the rows, namely rows 4 through 12, and columns, namely, columns g, h, i, j, l, m, p, q, r, s, t, and u, corresponding to the connected component B. The connected component A is entirely a tree structure because its circuit rank is zero, and therefore, cannot contain a BNS. If any BNS's exist in this model of Table I, they must be within the connected component B. As illustrated in FIGS. 33A and 33B, only this connected component B and the marked calls 129 through 156 of the matrix 102b corresponding to this connected component B need to be further analyzed for consistency by the program 14. The cells 121 through 128 are shown as blank to indicate that analysis of these cells is temporarily suspended.

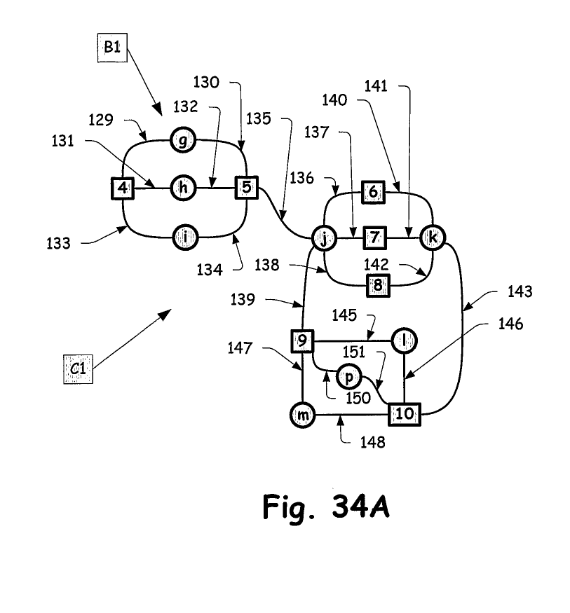

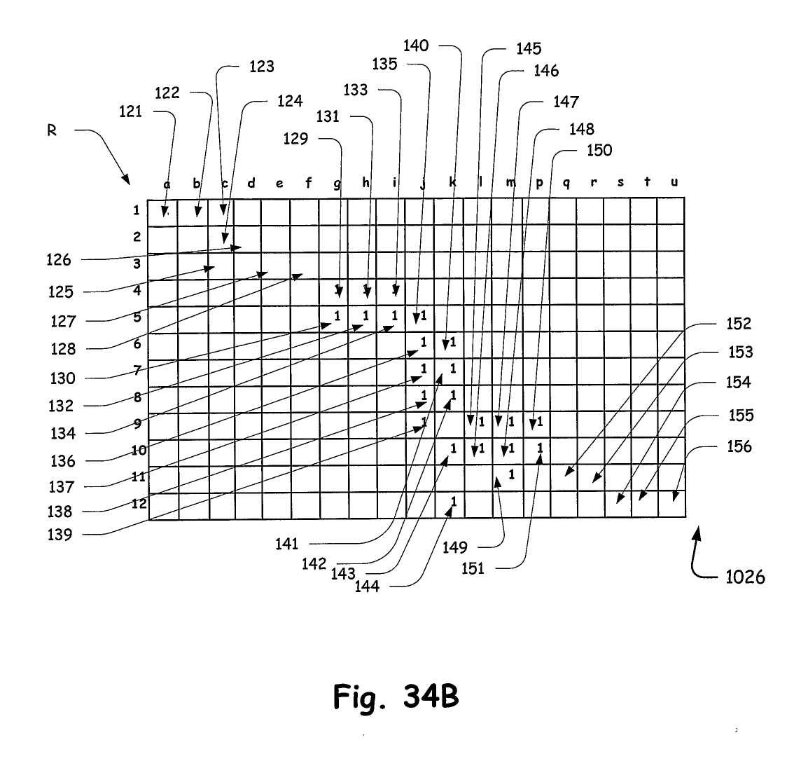

Step 3: The program 14 next uses the external tree routine to identify as tree structures the sub-models consisting of the equations 11 and 12, including their variable variables q, r, s, t, and u. Upon executing the external tree routine, the central processing unit 11 searches the matrix 102b for vertices having a local degree of one, and suspend temporarily edges (or cells) from further analysis until a circuit cluster has been identified and there no longer exist vertices having a local degree of one in the connected component B being analyzed. In this Example I, it is the portion of the matrix 102b corresponding to the circuit cluster B that is analyzed. This analysis by the external tree routine reveals that two external tree structures are identified marked as T1 and T2 in FIG. 33A. The program 14 now employs a routine that suspends temporarily the sub-model consisting of the equations 11 and 12 from further analysis as depicted in FIGS. 33A and 33B. This step is especially easy for the matrix 102b because the central processing unit 11 need only search for any row or column with a single marked cell. In this Example I, only one slash (/) appears in the cells 152, 153, 154, 155, and 156 corresponding to the variables q, r, s, t, and u and the equations 11 and 12. Consequently, the routine temporarily suspends from the matrix 102b these sub-models equations 11 and 12, leaving, as shown in FIG. 34A, a circuit cluster C1 with, as shown in FIG. 34B, the matrix 102b now modified so that only the cells 129 through 151 identified by a slash (/) as needing further analysis. The other cells 121 through 129 and 152 through 156 temporarily suspended from further analysis are blank

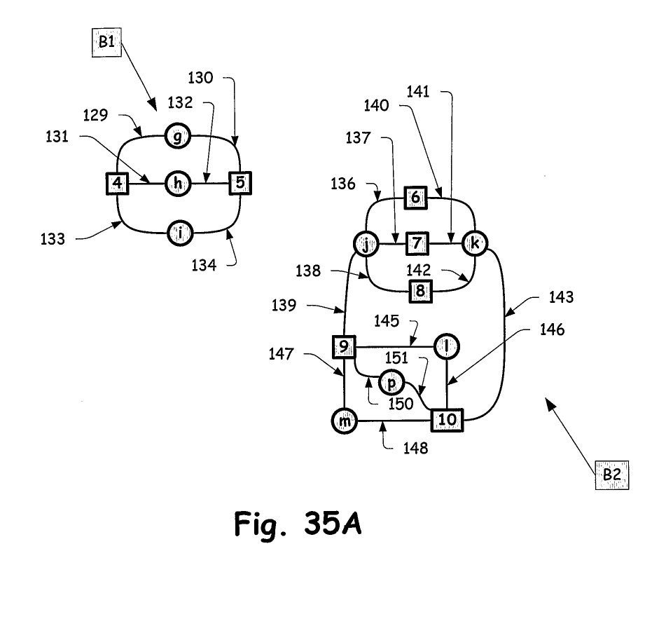

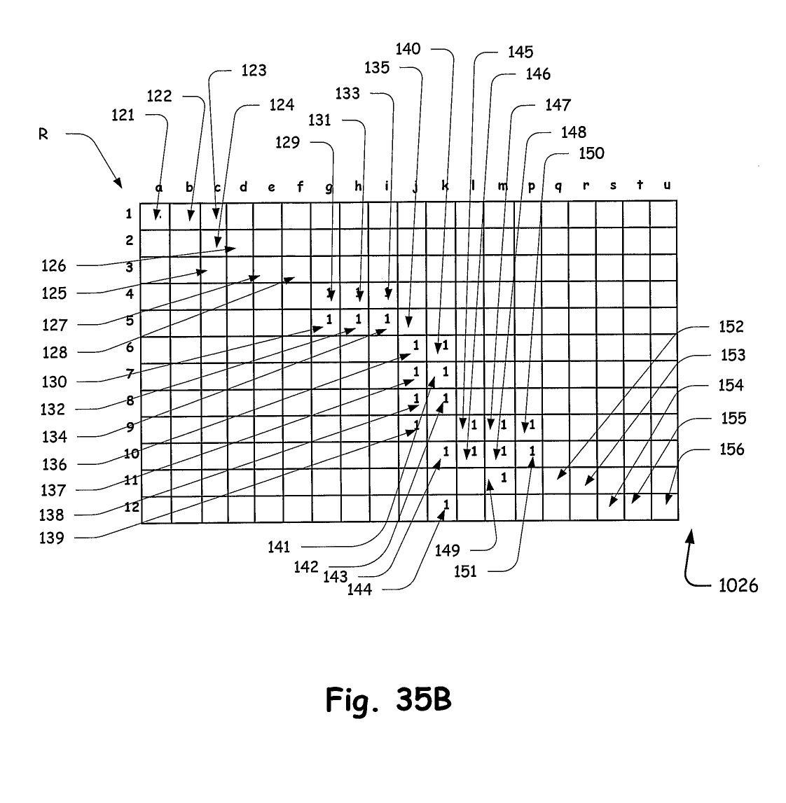

Step 4: The program 14 next uses the internal tree routine to determine if any internal tree structures are present within the circuit cluster C1, and identifies as an internal tree the sub-model B1 consisting of the equations 4 and 5 with the edge or cell 135 connecting this internal tree to the remained of the circuit cluster C1. The equations 4 and 5 are temporarily suspended before looking for separating vertices. Another routine now examines in the matrix 102b all marked cells 129 through 151 remaining from step 3 to determine whether or not any correspond to a separating vertex. In this routine, each vertex is temporarily suspended from analysis and the remainder of the circuit cluster C1 is tested for connectivity, again employing the connectivity routine. If an internal tree structure is discovered, it is temporarily suspended from further analysis. As illustrated in FIGS. 35A and 35B, this analysis results in the identification of two circuit clusters B1 and B2 that need to be further analyzed: the circuit cluster B1 corresponding to the marked cells 129 through 134 and circuit cluster B2 corresponding to the marked cells 136 through 151. As shown in FIG. 35B, the cell 135 is now blank.

Step 5: The program 14 next employs a routine that analyzes separately the portions of the matrix 102b corresponding to the remaining circuit clusters B1 and B2 for separating vertices—that is, vertices that, if removed, will separate two or more circuit clusters. The program 14 employs the connectivity routine as discussed above. In this example, as depicted in FIGS. 34A and 34B, the connectivity routine determines that there are no kissing circuit clusters within either of the remaining circuit clusters B1 and B2, which are non-kissing circuit clusters: the circuit cluster B1 is a sub-model consisting of the equations 4 and 5, and the circuit cluster B2 is a sub-model consisting of the equations 6, 7, 8, 9, and 10. If any BNS's exist, they must be in one or both of these circuit clusters B1 and B2.

Step 6: The program 14 now employs a routine that analyzes all possible sub-models of these circuit clusters B1 and B2 for a constraint potential p(HG)=0, or greater. The constraint potential p(HG) of a sub-model equals the number of nodes N in the sub-model less the number of knots K in the sub-model. Consequently, the constraint potential of the circuit cluster B1 is p(G_{B1})=2−3=−1; and the constraint potential of circuit cluster B2 is p(G_{B2})=5−5=0. Therefore, there cannot be a BNS within the circuit cluster B1 and the circuit cluster B2 is a nodal square (N−K=0), which must be further analyzed for any smaller nodal squares within it. The program 14 now employs a routine that analyzes each sub-model within the circuit cluster B2. Analysis of the sub-model consisting of the equations 9 yields a constraint potential of p(HG)=2-3=−1. Analysis of the sub-model consisting of the equations 6 and 7, the sub-model consisting of the equations 7 and 8, and the sub-model consisting of the equations 6 and 8 reveals that all three of these sub-models have a constraint potential of zero (0). Thus, all three are nodal squares and since there are no smaller nodal squares within them, these sub-models are the only three BNS's within the mathematical model of Table I.

Step 7: The program next employs a routine that determines whether the three BNS's identified in Step 6 overlap. Examining the active or marked cells 129 through 134 and cells 136 through 151 (those not suspended from analysis as shown in FIG. 35B) reveals that the three BNS's identified in Step 6 do indeed overlap at variables j and k, namely the cells 136 through 137 and cells 140 through 142. Upon analysis of the sub-model consisting of the equations 6, 7, and 8 sub-model, reveals that this sub-model has a constraint potential p(HG)=3−2=1, which is a clear case of intrinsic over-constraint, rendering the mathematical model of Table I inconsistent.

### Providing Consistency Repair Advice

The consistency repair program advises the human to remove either equations 6, 7 or 8, which would render the model consistent.

### Consistency Repair Action

After consultation with the model builders, the human operator, for example, chooses to remove equation 7. The repaired mathematical model is now consistent, permitting examination of computational requests.

### Determining Computational Allowability

With the model of Table I repaired by the removal of equation 7, the routines of the computation allowability subprogram 22, computation allowability repair advice subprogram 24, and computational request activation subprogram 26 are executed in connection with computational requests. The following ten computational requests of the above repaired model (removal of equation 7) are provided for illustration purposes, depicting how the subprograms 22, 24 and 26 operate:

a=f(b,d) Allowable: The computational flow rules for tree structures are satisfied. When d provides an input to 2, c can be computed, providing an input to 1, which, when provided with the independent variable b, can successfully compute a. Equation 3 is not used in this computation.
f=f(a,b,e) Allowable: The computational flow rules for tree structures are satisfied. With the inputs from a and b, 1 can compute c, which in conjunction of the independent variable e, permits 3 to compute f. Equation 2 is not used in this computation.
d=f(a,f) Not allowable: The computational flow is under-constrained at 1 and 3.

### ADVICE: hold b and f at constant values, or request d=f(a,b), or d=f(e,f).

d=f(a,b,e,f) Not allowable: The computational flow is over-constrained at c.

### ADVICE: request d=f(a,b), d=f(e,f), or d=f(c)

e=f(s,t) Not Allowable: the variables are in separated connected components and the request is under-constrained.
ADVICE: construct a bridge between the two components with a new equation d=f(s,t,f), and request: e=f(s,t) with f held constant.
u=f(s,t) Allowable: k is within a BNS, so it can provide a necessary input to equation 12, satisfying the (d−1) in; 1 out rule for nodes.
t=f(s) Not allowable: the computational flow is under-constrained at 12.

### ADVICE: request t=f(s) with u held constant, or request t=f(s,u)

g=f(i) Allowable: j is part of a BNS, and with i as an independent variable, the sub-model consisting of equations 4 and 5 becomes a resultant BNS, thereby determining a value of g for every value of i.
g=f(h,i) Not allowable: j is part of a BNS, and letting both h and i be independent variables over constrains the sub-model consisting of equations 4 and 5.

### ADVICE: request g=f(i) or g=f(h),

q=f(r,l) Allowable: j and k are within a BNS and their computational flow, coupled with 1 as an independent variable makes the sub-model consisting of equations 9 and 10 into a resultant BNS. Thus, m is determined and the computational flow through equation 11 is satisfied.

In summary, the Table I mathematical model's consistency is first addressed, and it is discovered that the mathematical model contains two overlapping BNS's. Thus, the repair program advises the removal of one of three of the equations 6, 7, and 8 that make up the BNS. The human operator chooses to remove equation 7, rendering the model consistent. After first addressing consistency and repairing the model, computational allowability is addressed. Half of the ten computational exemplar requests are determined by the program 14 to be allowable since they satisfy the computability rules. For the half that are unallowable, the program provides an advice to yield allowable computations.

### Overview

The computer product and computer of this invention as described above employ a unique program having routines that analyze a complex mathematical model and by a process of elimination identify a consistent mathematical model or an inconsistent model to be repaired. This program also includes routines that determine if a computational request is allowable, and if not, suggest allowable requests. One routine constructs a companion matrix of a hypergraph of the mathematical model to provide a homomorphic counterpart of the hypergraph. It is this matrix that contains all the information necessary about the model that is accessed by the routines as they are executed.

After storing the matrix in the memory of the computer, a series of routines interacting with the matrix are executed to determine if the model in consistent. The first of the series of routines analyzes the matrix using a connectivity algorithmic process to identify any mutually exclusive and exhaustive connected components of the model. The algorithmic connectivity process comprises:

(a) starting at any cell corresponding to a node or a knot and propagating connectedness along the cells corresponding to edges from said node or knot in all possible directions,

(b) repeating step (a) if a first iteration of step (a) does not fill up the entire model starting again at any node or knot which is not reached by the first iteration, and

(c) if needed to decompose completely the entire hypergraph, continually repeating propagating connectedness along the edges from any un-reached node or knot in all possible directions.

For each connected component the second routine of the series computes circuit rank using the formula CR=E−(N+K)+1, In this formula
CR is the circuit rank of a component,
E is the number of edges in a connected component,
N is the number of nodes in a connected component,
K is the number of knots in a connected component
   When CR=0, the connected component is an external tree structure. When CR is >0, the connected component contains a circuit cluster. A CR<0 indicates that the sub-model being analyzed is a disconnected component. Execution of the first routine of the series, however, insures that only connected components are being analyzed by the second routine of the series. The second routine of the series also temporarily suspends from further analysis any portion of the matrix identified as an external tree structure. The forth routine of the series analyzes each identified circuit cluster using the connectivity algorithmic process to identify any internal tree structures and kissing clusters within the circuit cluster being analyzed, and temporarily suspends from further analysis any portion of the matrix identified as an internal tree structures or kissing circuit clusters or both, to thereby identify target portions of the matrix where a nodal square may exist. The fifth routine of the series analyzes the target portions of the matrix to identify any sub-model therein that contains a nodal square by determining if a sub-model has a constraint potential equal to zero using the following formula:

p(HG)=N−K
where
   p(HG) is the constraint potential
   N is the number of nodes in the sub-model
   K is the number of knots in the sub-model,
      The sixth routine of the series identifies within any nodal square any basic nodal square. The seventh routine of the series determines whether any basic nodal squares, and resultant constraint domains thereof, overlap. Any such overlapping identifies an inconsistent mathematical model, and activates a consistency repair advice routine suggesting an alternate consistent mathematical model,

The consistency repair advice routine provides an advice that suggests removing one or more of the equations from the sub-model corresponding to the overlapping basic nodal squares, or constraint domains thereof, or converting one or more constants in the sub-model equations to a variable so that there are no longer overlapping basic nodal squares, rendering the model consistent.

After executing the above series of routines to determine if the model is consistent, or if not is repaired, a routine is executed to determine the allowability of a computational request imposed on a consistent mathematical model. This routine calculates a constraint potential p(HG) at every vertex or circuit cluster or both along a computational flow path extending from all independent variables and all variables held constant to the dependent variable. Only if the resultant constraint potential is equal to zero at each vertex or circuit cluster or both, will the computational request being imposed on the consistent mathematical model be allowed. If not, a computational request repair advice routine is executed that suggests one or more alternate allowable computational requests.

In the case where the constraint potential is greater than zero at any node or knot along the path, the computation is over-constrained and not allowable. In the case where the constraint potential is less than zero at any node or knot along the path, then the computation is under-constrained and not allowable. In such cases, the computational request repair advice routine provides an advice that adjustments must be made to the choice of independent variables, variables held constant, and dependent variables in order to bring the resultant constraint potential to zero along the entire path, thus obtaining allowable computational requests. When over-constraint occurs, the advice suggests (a) lowering the constraint by the elimination of basic nodal squares, forming a consistent sub-model, or (b) converting constants to variables. When under-constraint occurs, the advice suggests increasing the constraint by holding an appropriate number of variables forming a consistent sub-model at constant values.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A computer comprising
a memory,
a processor capable of performing a computational request imposed on a mathematical model stored in the memory,
an output device and an input device that enables a human operator to input into said memory a proposed mathematical model and impose a computational request upon said proposed mathematical model, and
a program stored in the memory that tests the consistency of the proposed mathematical model and the allowability of a computational request and provides to a human operator through the output device an advice that the proposed mathematical model is inconsistent and, when the proposed model is consistent, an advice when the computational request is unallowable.

2. The computer of claim 1 where the program provides through the output device an advice to the human operator suggesting one or more alternative consistent mathematical models when said proposed model is inconsistent.

3. The computer of claim 1 where the program provides through the output device an advice to the human operator suggesting one or more alternative allowable computational requests when an imposed computational request is unallowable.

4. A computer comprising
a memory,
a processor capable of performing a computational request imposed on a mathematical model stored in the memory,
an output device and an input device that enables a human operator to input into said memory a proposed mathematical model and impose a computational request upon said proposed mathematical model, and
a program stored in the memory that tests the consistency of the proposed mathematical model and the allowability of a computational request and provides to a human operator through the output device an advice that the proposed mathematical model is inconsistent and, when the proposed model is consistent, an advice when the computational request is unallowable,
said program providing through the output device
(a) an advice to the human operator suggesting one or more alternative consistent mathematical models when said proposed model is inconsistent, and
(b) an advice to the human operator suggesting one or more alternative allowable computational requests when an imposed computational request is unallowable.

5. The computer of claim 1 where the proposed mathematical model includes a plurality of variables and equations relating the variables to one another and the program includes
a routine that constructs a companion matrix of a hypergraph of the proposed mathematical model,
a routine that identifies any overlapping basic nodal squares within said companion matrix and any overlapping resultant constraint domains emanating from any so identified basic nodal square or squares,
a routine that generates an advice that the proposed mathematical model is inconsistent when an overlapping basic nodal square, or an overlapping resultant constraint domain thereof, is present within said companion matrix,
a routine that calculates a resultant constraint potential at each vertex and circuit clusters along a computational path from all independent variables, and all independent variable held constant, to a dependent variable, and
a routine that generates an advice that the computational request is unallowable when said resultant constraint potential is not equal to zero at each vertex or circuit cluster or both along the entire computational path.

6. The computer of claim 5 where said program includes a routine that provides an advice suggesting at least one way to make the proposed mathematical model consistent when said proposed mathematical model is inconsistent.

7. The computer of claim 5 where said program includes a routine that provides an advice suggesting at least one alternate allowable computational request when an imposed computational request is unallowable.

8. The computer of claim 5 where said program includes
(a) a routine that identifies within said companion matrix sub-models comprising nodes, knots, and edges identifying related nodes and knots and computes circuit rank of a sub-model using the formula
CR=E−(N+K)+1
where
CR is circuit rank,
N equals the number of nodes in the connected sub-model,
K equals the number of knots in the connected sub-model,
E equals the number of edges in the connected sub-model,
if CR is 0, then the sub-model has a tree structure,
if CR>0, then the sub-model has a circuit cluster,
and
(b) a routine that identifies any basic nodal square within any identified circuit cluster or clusters, and if any so identified basic nodal square or squares, or a resultant constraint domains emanating from any so identified basic nodal square or squares, overlap.

9. The computer of claim 8 where said program includes a routine that temporarily suspends from the companion matrix for the purpose of identifying a basic nodal square any sub-models having a tree structure.

10. The computer of claim 8 where said program includes a routine that temporarily suspends from the companion matrix for the purpose of identifying a basic nodal square any connected sub-model that has a circuit rank equal to zero.

11. A computer that determines whether a proposed mathematical model and computational requests made upon said model are well posed, said model including a plurality of variables and equations relating the variables to one another, said computer comprising
means for determining whether the model is consistent,
means for suggesting at least one alternative consistent model if said proposed model is inconsistent,
means for determining whether a computational request is allowable,
means for suggesting at least one alternative allowable computational request if an initial computational request is unallowable,

12. The computer of claim 11 where said means of determining whether the mathematical model is consistent comprises
means for constructing a companion matrix of a hypergraph of the model comprising rows and columns, including means for assigning one equation to each row of the matrix and one variable to each column of the matrix, with cells being formed at each intersection of a row and a column,
means for identifying related equations and variables as edges, including means for placing a symbol in any cell of the matrix that corresponds to an intersection of a related equation and a related variable,
means for analyzing the matrix to determine if the entire model is a connected component and, if not, identifying any connected components within the model,
means for computing a circuit rank for each connected component of the model and temporarily suspending analysis of sub-models in the matrix corresponding to any connected component with a circuit rank equal to zero,
means for analyzing the matrix corresponding to any connected component with a circuit rank greater than zero, including means for identifying any sub-model of each said connected component with a vertex with a local degree equal to one and temporarily suspending analysis thereof, with any remaining rows, columns, and cells within each said connected component corresponding to a first circuit cluster that requires further analysis,
means for identifying any separating vertices and temporarily suspending analysis thereof, with remaining rows, columns, and cells within said first circuit cluster corresponding to one or more second circuit clusters that require further analysis,
means for calculating the constraint potential of each sub-model within the each said second circuit cluster, identifying any sub-model with a constraint potential equaling zero as a nodal square,
means for analyzing each nodal square, identifying as a basic nodal square those which have no smaller nodal squares within them,
means for detecting whether any identified basic nodal squares, or their resultant constraint domains, overlap,
said model being consistent (a) if the identified basic nodal squares do not overlap and (b) if the resultant constraint domains of the identified basic nodal squares do not overlap.

13. The computer of claim 12 where the means for analyzing the matrix to determine if the entire model is a connected component and, if not, identifying any connected component within the model, include means for executing a connectivity algorithm.

14. The computer of claim 13 where the means for executing a connectivity algorithm comprise
means for determining a starting vertex,
means for propagating connectedness along edges of the matrix in all possible directions from said starting vertex,
means for determining whether all edges have been traversed,
means for determining a starting vertex within a set of edges which have not been traversed,
means for repeating the propagation of connectedness until the entire mathematical model has been decomposed into connected sub-models.

15. The computer of claim 11 where said means for determining whether a computational request is allowable comprises
means for employing predetermined computational flow rules in a tree structure,
means for detecting the formation of any resultant basic nodal squares formed as a result of the computational flow rules,
means for computing a constraint potential along a computational path from all independent variables and variables held constant to the dependent variable, said computational request being allowable if each said constraint potential equals zero and unallowable if any constraint potential does not equal zero.

16. The computer of claim 15 where the predetermined computational flow rules provide
For Nodes: (dᵥ−1) inputs will permit 1 output
For Knots: 1 input will permit (dᵥ−1) outputs
where dᵥ is the local degree at any vertex and is equal to the number of edges that intersect a vertex.

17. The computer of claim 11 where the means for suggesting an alternative consistent mathematical model when a proposed mathematical model has been determined to be inconsistent comprise
means for identifying the location of overlapping basic nodal squares, and overlapping constraint domains.
means for selecting and removing equations from the model to eliminate overlapping basic nodal squares, or converting constants and coefficients into variables, thereby rendering the mathematical model consistent.

18. The computer of claim 11 where the means of suggesting alternate computational requests comprises
means for determining those vertices and circuit clusters along the computational path where the constraint potential is less than zero and suggesting alternatives of additional variables held constant or additional independent variables to bring the constraint potential up to zero, thereby rendering the computational request allowable,
means for determining those vertices and circuit clusters along the computational path where the constraint potential is greater than zero and suggesting alternatives of fewer variables held constant or fewer independent variables or fewer equations to bring the constraint potential down to zero, thereby rendering the computational request allowable.

19. A computer including
a memory in which is stored
a companion matrix of a hypergraph of a proposed mathematical model, and
a program that executes in conjunction with the matrix the following routines in sequence:
(a) a routine that identifies each connected component within the model, thereby determining if the model is a single, unitary connected component or comprises two or more detached connected components,
(b) a routine that determines whether any connected component identified by the routine of paragraph (a) is a tree structure by computing the circuit rank of each connected component,
(c) a routine that for each connected component identified by the routine of paragraph (b) as not being tree structure determines if any external tree structure exists therein and temporarily suspends from further analysis any so identified external tree structure, thereby identifying any first circuit cluster within said connected component analyzed,
(d) a routine that determines if any internal tree structure exists within said a first circuit cluster identified by the routine of paragraph (c), and if so, temporarily suspends from further analysis any so identified internal tree structure, thereby identifying one or more second circuit clusters within said first circuit cluster,
(e) a routine that identifies all kissing circuit clusters within any of said second circuit clusters identified by the routine of paragraph (d), thereby identifying any circuit clusters that may contain a nodal square,
(f) a routine that identifies any basic nodal square within any nodal square identified by the routine of paragraph (e),
(g) a routine that determines whether any basic nodal squares identified by the routine of paragraph (f), and resultant constraint domains thereof, overlap,
(h) a routine that, in the case of an overlap identified by the routine of paragraph (f), provides an advice to a human operator that the model is inconsistent,
(i) a routine that enables a human operator to impose on a consistent model a computational request and determines if the request is allowable.

20. The routine of claim 19 where the program includes a routine that provides an advice suggesting one or more alternative consistent mathematical models when said proposed model is inconsistent.

21. The computer of claim 19 where the program provides an advice suggesting one or more alternative allowable computational requests when an imposed computational request is unallowable.

22. A computer comprising
a memory storing a program and a processor for executing the program, said program including
a matrix construction routine that constructs a companion matrix of a hypergraph of the mathematical model to provide a homomorphic counterpart of the hypergraph that enables the processor to execute the following routines to determine if the model in consistent and if a computational request imposed on the model is allowable,
said matrix having intersecting rows and columns of cells, with each individual row of cells being a node corresponding to one equation of the model, each individual column of cells being a knot corresponding to one variable of the equations, said routine identifying each individual cell as an edge wherever a node and knot are related,
a routine that analyzes the matrix using a connectivity algorithmic process to identify any mutually exclusive and exhaustive connected components of the model,
a routine that for each connected component computes circuit rank using the formula CR=E−(N+K)+1, where
CR is the circuit rank of a component,
E is the number of edges in a connected component,
N is the number of nodes in a connected component,
K is the number of knots in a connected component,
when CR=0, a connected component is a tree structure,
when CR is >0, a connected component includes at least one circuit cluster,
a routine that temporarily suspends from further analysis any portion of the matrix identified as an external tree structure,
a routine that analyzes each identified circuit cluster using a connectivity algorithmic process to identify any internal tree structures and kissing clusters within the circuit cluster being analyzed, and temporarily suspends from further analysis any portion of the matrix identified as an internal tree structures or kissing clusters or both, to thereby identify target portions of the matrix where a nodal square may exist,
a routine that analyzes the target portions of the matrix to identify any sub-model therein that contains a nodal square by determining if a sub-model has a constraint potential equal to zero using the formula
p(HG)=N−K
where
p(HG) is the constraint potential
N is the number of nodes in the sub-model
K is the number of knots in the sub-model,
a routine that identifies within any nodal square any basic nodal square,
a routine that determines whether any basic nodal squares, and resultant constraint domains thereof, overlap, whereby overlapping identifies an inconsistent mathematical model, and activates a consistency repair advice routine suggesting an alternate consistent mathematical model,
a routine that determines the allowability of a computational request imposed on a consistent mathematical model by calculating a constraint potential p(HG) at every node and knot along a computational flow path extending from all independent variables and all variables held constant to the dependent variable, and enables the computational request to be imposed on the consistent mathematical model if the resultant constraint potential is equal to zero at each said node and knot, and if not, activates a computational request repair advice routine suggesting one or more alternate allowable computational requests.

23. The computer of claim 22 where the consistency repair advice routine provides an advice that suggests removing one or more of the equations from the sub-model corresponding to the overlapping basic nodal squares or converting one or more constants in said sub-model equations to a variable so that there are no longer overlapping basic nodal squares.

24. The computer of claim 23 where the consistency repair advice routine provides an advice that suggests converting one or more of the constants in the sub-model equations of the overlapping basic nodal squares or constrain domains thereof to a variable, thus rendering the basic nodal square into a sub-model with a constraint potential equal to or less than zero.

25. The computer of claim 22 where
in the case that constraint potential is greater than zero at any node or knot along the path, the computation is over-constrained and not allowable,
in the case that the constraint potential is less than zero at any node or knot along the path, then the computation is under-constrained and not allowable,
in such cases, the computational request repair advice routine provides an advice that adjustments must be made to the choice of independent variables, variables held constant, and dependent variables in order to bring the resultant constraint potential to zero along the entire path, thus obtaining allowable computational requests.

26. The computer of claim 25
when over-constraint occurs, the advice suggests (a) lowering the constraint by the elimination of basic nodal squares forming a consistent sub-model, or (b) converting constants to variables, and
when under-constraint occurs, the advice suggests increasing the constraint by holding an appropriate number of variables forming a consistent sub-model at constant values.

27. The computer of claim 22 where the algorithmic connectivity process comprising
(a) starting at any cell corresponding to a node or a knot and propagating connectedness along the cells corresponding to edges from said node or knot in all possible directions,
(b) repeating step (a) if a first iteration of step (a) does not fill up the entire model, starting again at any node or knot which is not reached by the first iteration, and
(c) if needed to completely decompose the entire hypergraph, continually repeating propagating connectedness along the edges from any un-reached node or knot in all possible directions.

28. A computer program product for controlling a computer to execute a program that determines (1) the consistency of a mathematical model including a plurality of equations, each equation comprising one or more independent variables, and (2) the allowability of a computational request imposed on the model, said product comprising
a routine that constructs a companion matrix of a hypergraph of the mathematical model, said companion matrix including rows and columns that intersect to form a cell at each intersection, where each row corresponds to one equation and each column corresponds to one variable,
a routine that identifies each cell that relates an equation and to a variable,
a routine that locates within the companion matrix one or more basic nodal squares,
a routine that determines if any of the basic nodal squares overlap and if any resultant constraint domains emanating from the basic nodal squares overlap,
a routine that provides an advice that the model is inconsistent if any of the basic nodal squares, or if any resultant constraint domains, overlap,
a routine that determines the allowability of a computational request imposed on a consistent mathematical model, and
a routine that imposes an allowable computational request on a consistent mathematical model.

29. The computer program product of claim 28 where the routine that determines the allowability of a computational request imposed on a consistent mathematical model comprises
a routine that constructs a companion matrix of a directed hypergraph of the consistent mathematical model,
a routine that identifies a computational flow path for a specific computational request imposed on the consistent mathematical model, said path including all independent variables and variables held constant, and a dependent variable corresponding to the specific computational request, and
a routine that calculates a constraint potential along the entire computational flow path and, if the constraint potential equals zero along the computational flow path, the computational request is allowable.

30. A computer program product for controlling a computer to execute a program that determines the consistency of a mathematical model, and the allowability of a computational request imposed on the model, said product comprising
a routine that constructs a companion matrix of the model corresponding to the model's hypergraph,
a routine that identifies by a process of elimination any basic nodal squares within the companion matrix that do not overlap and do not have overlapping resultant constraint domains emanating from the identified basic nodal squares, thereby confirming that the model is consistent,
a routine that determines the allowability of a computational request imposed on a consistent mathematical model, and
a routine that imposes an allowable computational request on a consistent mathematical model.
